(19) United States
(12) Patent Application Publication
(10) Pub. No.: US 2026/0276062 A1
(43) Pub. Date: Sep. 17, 2026

(54) CHAIN

(71) Applicant: TSUBAKIMOTO CHAIN CO., Osaka-shi, Osaka (JP)

(72) Inventor: Tsutomu Tokumoto, Osaka-shi, Osaka (JP)

(73) Assignee: TSUBAKIMOTO CHAIN CO., Osaka-shi, Osaka (JP)

(21) Appl. No.: 19/474,047

(22) PCT Filed: Aug. 2, 2023
(86) PCT No.: PCT/JP2023/028283

§ 371 Date: Oct. 9, 2025

(30) Foreign Application Priority Data
Apr. 12, 2023 (JP) 2023-064977

(51) Int. Cl. F16G 13/07; F16G 13/18

(52) U.S. Cl. CPC F16G 13/07; F16G 13/18

(57) ABSTRACT

A chain includes: a plurality of first links that are pivotally linked to each other and form a first helical link linkage extending helically; a plurality of second links that are pivotally linked to each other and form a second helical link linkage extending helically; and a plurality of linking members that link the first links and the second links corresponding one to one to the first links, to link the first helical link linkage and the second helical link linkage and form a double helix structure.

### TECHNICAL FIELD

The present disclosure relates to a chain.

### BACKGROUND ART

For example, Patent Document 1 discloses a chain capable of being bent in a plurality of directions as viewed in an extending direction (traveling direction).

### PRIOR ART DOCUMENT

### Patent Document

Patent Document 1: JP-A-7-4473

### SUMMARY OF THE INVENTION

### Problems to be Solved by the Invention

However, in the case of the chain described in Patent Document 1, a drive source such as a gear engaged with the chain needs to have a special shape. Alternatively, the chain needs to be fitted with an option, such as a roller, to engage with the drive source. Therefore, the chain has low versatility.

Therefore, an object of the present disclosure is to provide a highly versatile structure that can be used as it is in a chain that can be bent in a plurality of directions as viewed in an extending direction.

### Solutions to the Problems

In order to solve the above problems, according to one aspect of the present disclosure, provided is a chain including:
a plurality of first links that are pivotally linked to each other and form a first helical link linkage extending helically;
a plurality of second links that are pivotally linked to each other and form a second helical link linkage extending helically; and
a plurality of linking members that link the first links and the second links corresponding one to one to the first links, to link the first helical link linkage and the second helical link linkage and form a double helix structure.

### Effect of the Invention

According to the present disclosure, it is possible to provide a highly versatile structure that can be used as it is in a chain that can be bent in a plurality of directions as viewed in the extending direction.

### BRIEF DESCRIPTION OF DRAWINGS

FIG. 1 is a perspective view of a part of a chain according to a first embodiment of the present disclosure.

FIG. 2 is a top view of a part of the chain according to the first embodiment.

FIG. 3 is an exploded perspective view of a part of the chain according to the first embodiment.

FIG. 4A is a perspective view of a plurality of first links in a state of being linked to each other.

FIG. 4B is a front view of a plurality of first links in a state of being linked to each other (first helical link linkage).

FIG. 4C is an exploded perspective view of the plurality of first links.

FIG. 5A is a perspective view of a plurality of second links in a state of being linked to each other.

FIG. 5B is a front view of a plurality of second links in a state of being linked to each other (second helical link linkage).

FIG. 5C is an exploded perspective view of a plurality of second links.

FIG. 6 is a perspective view illustrating first and second helical link linkages forming a double helix structure.

FIG. 7 is a perspective view illustrating first and second links in a state of being linked via a linking member.

FIG. 8 is an exploded perspective view for describing linking of a plurality of first and second links via a plurality of linking members.

FIG. 9A is a cross-sectional view of the chain taken along line S1-S1 illustrated in FIG. 1.

FIG. 9B is a cross-sectional view of the chain taken along line S2-S2 illustrated in FIG. 1.

FIG. 10A is a perspective view illustrating a part of the chain that is bent to one side in a width direction.

FIG. 10B is a perspective view illustrating a part of the chain that is bent to the other side in the width direction.

FIG. 10C is a perspective view illustrating a part of the chain that is bent to one side in a thickness direction.

FIG. 10D is a perspective view illustrating a part of the chain that is bent to the other side in the thickness direction.

FIG. 11 is a perspective view illustrating the chain according to the first embodiment in a state of being engaged with a plurality of sprockets.

FIG. 12 is a perspective view illustrating the chain according to the first embodiment and a rotating body as an example.

FIG. 13 is a perspective view illustrating the chain according to the first embodiment and another example of rotating bodies.

FIG. 14 is a perspective view of an endless chain according to the first embodiment.

FIG. 15 is a perspective view of a part of a chain according to a second embodiment.

FIG. 16 is a top view of a part of the chain according to the second embodiment.

FIG. 17 is an exploded perspective view of a part of the chain according to the second embodiment.

FIG. 18A is a front view of a plurality of first links linked to each other (first helical link linkage).

FIG. 18B is a front view of a plurality of second links linked to each other (second helical link linkage).

FIG. 19A is a cross-sectional view of the chain taken along line S3-S3 illustrated in FIG. 15.

FIG. 19B is a cross-sectional view of the chain taken along line S4-S4 illustrated in FIG. 15.

FIG. 20 is a perspective view of a part of a chain according to a third embodiment.

FIG. 21 is an exploded perspective view of a part of the chain according to the third embodiment.

FIG. 22A is a front view of each of a plurality of first links linked to each other (first helical link linkage).

FIG. 22B is a front view of each of a plurality of second links linked to each other (second helical link linkage).

FIG. 23A is a cross-sectional view of the chain taken along line S5-S5 illustrated in FIG. 20.

FIG. 23B is a cross-sectional view of the chain taken along line S6-S6 illustrated in FIG. 20.

FIG. 24 is a perspective view of a part of a chain according to a fourth embodiment.

FIG. 25 is an exploded perspective view of a part of the chain according to the fourth embodiment.

FIG. 26A is a front view of each of a plurality of first links linked to each other (first helical link linkage).

FIG. 26B is a front view of each of a plurality of first links linked to each other (first helical link linkage).

FIG. 27A is a cross-sectional view of the chain taken along line S7-S7 illustrated in FIG. 24.

FIG. 27B is a cross-sectional view of the chain taken along line S8-S8 illustrated in FIG. 24.

FIG. 28 is a perspective view of a part of a chain according to a fifth embodiment.

FIG. 29 is an exploded perspective view of a part of the chain according to the fifth embodiment.

FIG. 30A is a front view of each of a plurality of first links linked to each other (first helical link linkage).

FIG. 30B is a front view of each of a plurality of second links linked to each other (second helical link linkage).

FIG. 31 is an exploded perspective view for describing linking of a plurality of first and second links via a plurality of linking members.

FIG. 32 is a perspective view of a part of a chain according to a sixth embodiment.

FIG. 33 is a perspective view of first and second linking members in the chain according to the sixth embodiment.

FIG. 34 is a perspective view illustrating first and second links in a state of being linked via linking members.

FIG. 35 is a cross-sectional view of the chain taken along line S9-S9 illustrated in FIG. 32.

FIG. 36 is a perspective view illustrating another example of a joint.

FIG. 37 is a perspective view illustrating still another example of a joint.

FIG. 38 is a perspective view of a part of a chain of an example variation.

FIG. 39 is a perspective view of a part of a chain as another example variation.

FIG. 40 is a perspective view of a part of a chain as still another example variation.

### DETAILED DESCRIPTION

A chain according to an aspect of the present disclosure includes: a plurality of first links that are pivotally linked to each other and form a first helical link linkage extending helically; a plurality of second links that are pivotally linked to each other and form a second helical link linkage extending helically; and a plurality of linking members that link the first links and the second links corresponding one to one to the first links, to link the first helical link linkage and the second helical link linkage and form a double helix structure.

According to such an aspect, it is possible to provide a highly versatile structure that can be used as it is in a chain that can be bent in a plurality of directions as viewed in the extending direction.

For example, each first link has one side to which an adjacent first link is linked and has another side to which another adjacent first link is linked, the first link pivots with respect to the adjacent first link about a first pivot centerline, and the first link pivots with respect to the other adjacent first link about a second pivot centerline extending in a direction different from the first pivot centerline as viewed in an extending direction of the chain. In addition, each second link has one side to which an adjacent second link is linked and has another side to which another adjacent second link is linked, the second link pivots with respect to the adjacent second link about a third pivot centerline, and the second link pivots with respect to the other adjacent second link about a fourth pivot centerline extending in a direction different from the third pivot centerline as viewed in the extending direction. Furthermore, the linking members link the first helical link linkage and the second helical link linkage such that: the first pivot centerline of each of the first links and the third pivot centerline of the corresponding one of the second links are located on a same straight line; and the second pivot centerline of each of the first links and a fourth pivot centerline of the corresponding one of the second links are located on a same straight line.

For example, the chain may include: as the linking members, first and second pins. Each of the first pins links and supports the two consecutive first links pivotally with respect to each other about the first pivot centerline, and links and supports the two consecutive second links pivotally with respect to each other about the third pivot centerline. Each of the second pins links and supports the two consecutive first links pivotally with respect to each other about the second pivot centerline, and links and supports the two consecutive second links pivotally with respect to each other about the fourth pivot centerline.

For example, the chain may include: as the linking members, first and second joints. Each of the first joints includes a first link support that links and supports the two consecutive first links pivotally with respect to each other about the first pivot centerline, a second link support that links and supports the two consecutive second links pivotally with respect to each other about the third pivot centerline, and a main body including a space penetrating in an extending direction of the chain. Each of the second joints includes a third link support that links and supports the two consecutive first links pivotally with respect to each other about the second pivot centerline, a fourth link support that links and supports the two consecutive second links pivotally with respect to each other about the fourth pivot centerline, and a main body including a space penetrating in an extending direction of the chain.

For example, each of the first pivot centerlines and a corresponding one of the second pivot centerlines are orthogonal to each other at an angle of 90 degrees as viewed in the extending direction.

For example, each of the first pivot centerlines and a corresponding one of the second pivot centerlines cross at an angle of 60 degrees as viewed in the extending direction.

For example, each of the first links and the second links may have an L-shape as viewed in an extending direction of the chain such that contours of the first helical link linkage and the second helical link linkage each have a rectangular shape as viewed in an extending direction of the chain.

For example, each of the first links and the second links may have an arc shape as viewed in an extending direction of the chain such that contours of the first helical link linkage and the second helical link linkage each have a circular shape as viewed in an extending direction of the chain.

For example, each of the first links and the second links may have a same shape.

For example, the first links may be a plurality of types of first links having different shapes from each other, and the second links may be a plurality of types of second links having different shapes from each other.

For example, the plurality of types of first links and the plurality of types of second links may include links of a same shape.

Hereinafter, a plurality of embodiments according to the present disclosure is described with reference to the drawings.

### First Embodiment

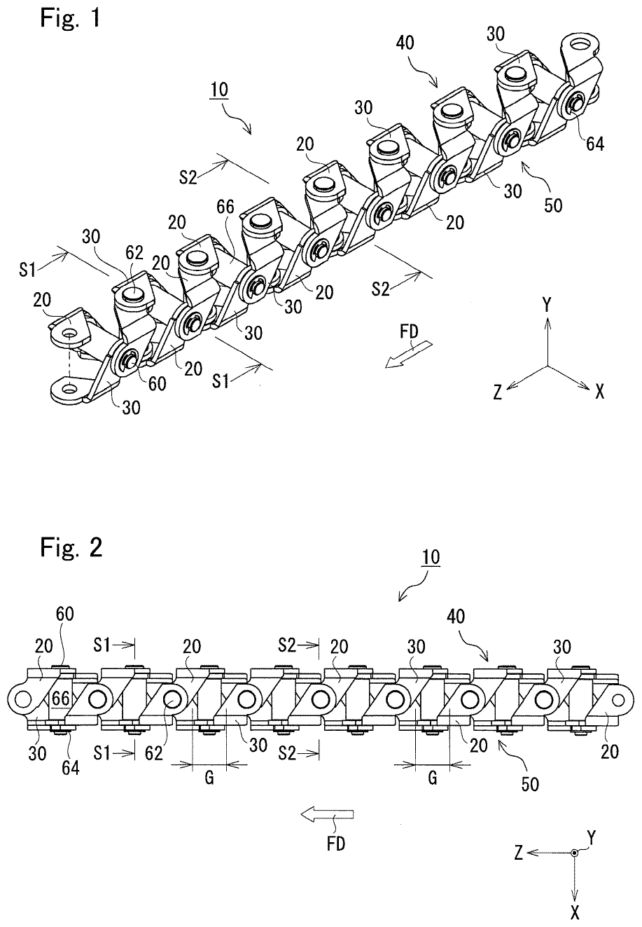

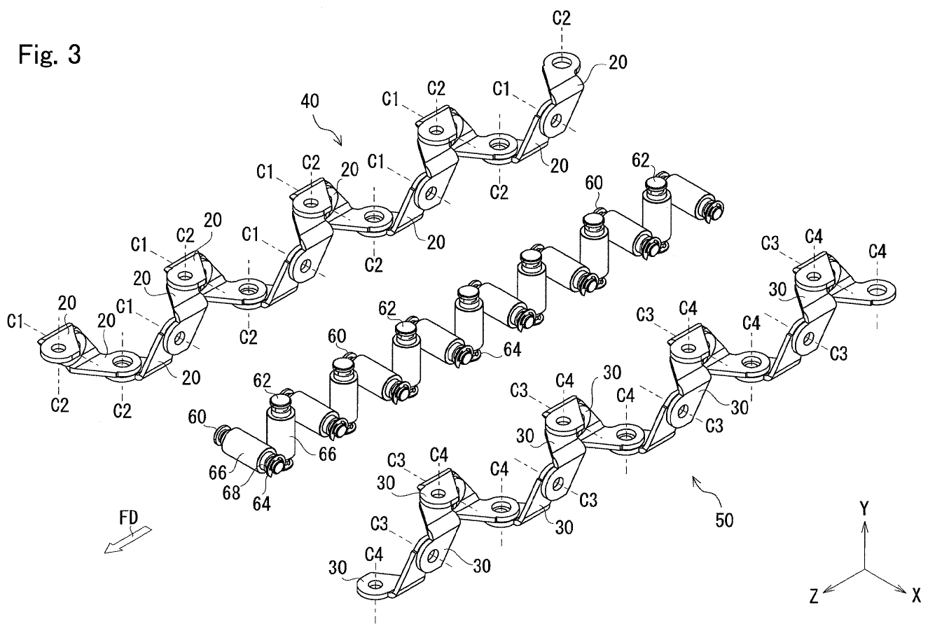

FIG. 1 is a perspective view of a part of a chain according to a first embodiment of the present disclosure. FIG. 2 is a top view of a part of the chain according to the first embodiment. FIG. 3 is an exploded perspective view of the chain according to the first embodiment.

Note that an X-Y-Z orthogonal coordinate system illustrated in the drawings is for facilitating understanding of the embodiment of the present disclosure, and does not limit the embodiment of the present disclosure. A Z-axis direction indicates an extending direction of the chain, an X-axis direction indicates a width direction, and a Y-axis direction indicates a thickness direction.

The extending direction (Z-axis direction) of the chain is a direction in which the chain moves when the chain is used. When the chain moves along the straight path, the extending direction of the chain corresponds to the extending direction of the straight path. When the chain moves along a curved path, the extending direction of the chain corresponds to the tangential direction of the curved path. In some drawings, the traveling direction of the chain is indicated by a white arrow FD in order to facilitate understanding of the embodiment of the present disclosure.

As illustrated in FIGS. 1 to 3, a chain 10 according to the first embodiment includes a plurality of first links 20 and a plurality of second links 30.

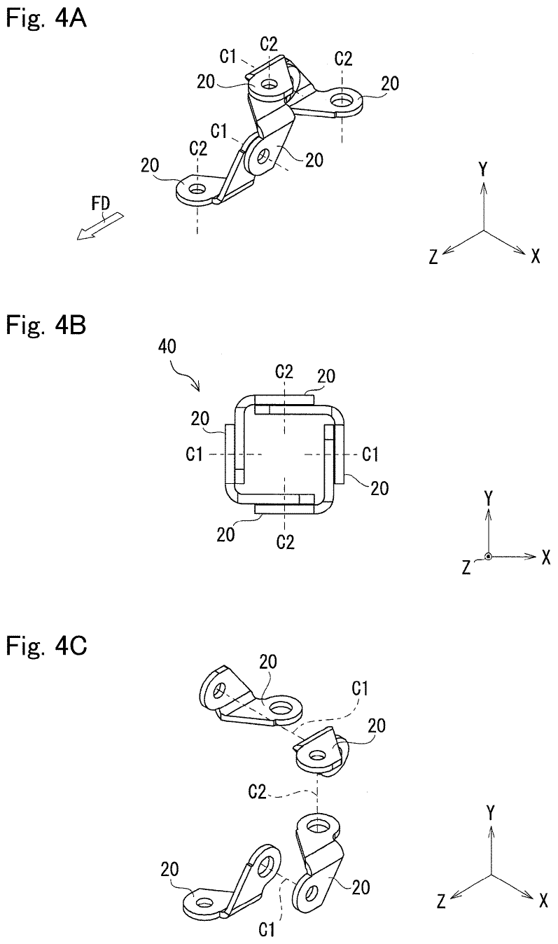

FIG. 4A is a perspective view of the plurality of first links in a state of being linked to each other. FIG. 4B is a front view of the plurality of first links in a state of being linked to each other (a first helical link linkage). FIG. 4C is an exploded perspective view of the plurality of first links.

As illustrated in FIGS. 4A to 4C, in the first embodiment, a plurality of first links 20 have the same shape. In the case of first embodiment, each first link 20 is bent as viewed in the extending direction of the chain 10 while extending in the extending direction (Z-axis direction) of the chain 10. In other words, the first link 20 has an L shape as viewed in the extending direction of the chain 10.

As illustrated in FIGS. 3 and 4A to 4C, the plurality of first links 20 are linked in series. In other words, each first link 20 has one side portion and the other portion in the extending direction of the chain (Z-axis direction). The one side portion of the first link 20 is linked with the other side portion of an adjacent first link 20. The other side portion of the first link 20 is linked with the one side portion of another adjacent first link 20. A specific linking method is described below in detail.

Each of the first links 20 pivots about the first and second pivot centerlines C1, C2. Specifically, each first link 20 is linked, on its one side, with an adjacent first link 20 and is pivotal with respect to the adjacent first link 20 about the first pivot centerline C1, while each first link 20 is linked, on its other side, with another adjacent first link 20 and is pivotal with respect to the other adjacent first link 20 about the second pivot centerline C2.

The first pivot centerline C1 and the second pivot centerline C2 extend in different directions from each other. Specifically, the first pivot centerline C1 crosses the second pivot centerline C2 as viewed in the extending direction (Z-axis direction) of the chain 10. In the case of the first embodiment, the extending direction of the first pivot centerline C1 (X-axis direction) and the extending direction of the second pivot centerline C2 (Y-axis direction) cross substantially at an angle of 90 degrees as viewed in the extending direction of the chain 10.

When each of the plurality of first links 20 is linked in series with the adjacent first links 20 pivotally about the first and second pivot centerlines C1 and C2, a first helical link linkage 40 extending in a helix shape is formed as illustrated in FIG. 3. The first helical link linkage 40 is a flexible link linkage including a plurality of first pivot centerlines C1 and a plurality of second pivot centerlines C2 alternately arranged in the extending direction (Z-axis direction) of the chain 10.

The term “helix” as used herein refers to a three-dimensional curve that goes in the direction of a reference line extending in one direction while circling around the reference line. In the present disclosure, the reference line of the helix corresponds to a line extending in the extending direction (Z-axis direction) of the chain 10 and passing through the cross-sectional shape of the chain 10 orthogonal to the extending direction (that is, a line located in the contour of the cross-sectional as viewed in the extending direction).

As described above, in the case of the first embodiment, the plurality of first links 20 have the same shape, and the first and second pivot centerlines C1 and C2 are substantially orthogonal as viewed in the extending direction (Z-axis direction) of the chain 10. Therefore, as illustrated in FIG. 4A, four consecutive first links 20 correspond to one cycle (one pitch) of the first helical link linkage 40. In addition, the four consecutive first links 20, that is, the first helical link linkage 40 have a substantially square contour as viewed in the extending direction (Z-axis direction) of the chain 10, as illustrated in FIG. 4B.

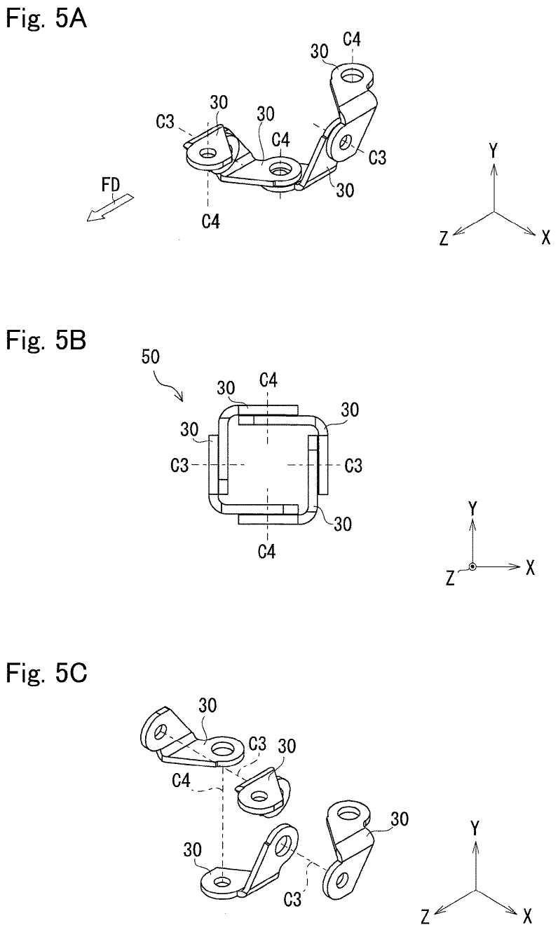

FIG. 5A is a perspective view of a plurality of second links in a state of being linked to each other. FIG. 5B is a front view of the plurality of second links in a state of being linked to each other (second helical link linkage). FIG. 5C is an exploded perspective view of the plurality of second links.

As illustrated in FIGS. 5A to 5C, in the case of the first embodiment, the plurality of second links 30 have the same shape. Furthermore, in the case of the first embodiment, the first links 20 and the second links 30 have the same shape. In other words, the chain 10 according to the first embodiment is formed of one type of links. Therefore, each second link 30 is also bent as viewed in the extending direction of the chain 10 while extending in the extending direction (Z-axis direction) of the chain 10. In other words, the second link 30 also has an L shape as viewed in the extending direction of the chain 10.

As illustrated in FIGS. 3 and 5A to 5C, the plurality of second links 30 are linked in series. In other words, each second link 30 has one side portion and the other side portion in the extending direction of the chain 10 (Z-axis direction). The one side portion of the second link 30 is linked with the other side portion of an adjacent second link 30. The other side portion of the second link 30 is linked with the one side portion of another adjacent second link 30. A specific linking method is described below in detail.

Furthermore, each second link 30 is linked, on its one side, with an adjacent second link 30 and is pivotal with respect to the adjacent second link 30 about the third pivot centerline C3, while each second link 30 is linked, on its other side, with another adjacent second link 30 and is pivotal with respect to the other adjacent second link 30 about the fourth pivot centerline C4.

The third pivot centerline C3 and the fourth pivot centerline C4 extend in different directions from each other. Specifically, the third pivot centerline C3 crosses the fourth pivot centerline C4 as viewed in the extending direction (Z-axis direction) of the chain 10. In the case of the first embodiment, the extending direction of the third pivot centerline C3 (X-axis direction) and the extending direction of the fourth pivot centerline C4 (Y-axis direction) cross substantially at an angle of 90 degrees as viewed in the extending direction of the chain 10.

When each of the plurality of second links 30 is linked in series with the adjacent second links 30 pivotally about the third and fourth pivot centerlines C3 and C4, a second helical link linkage 50 extending in a helix shape is formed as illustrated in FIG. 3. The second helical link linkage 50 is a flexible link linkage including a plurality of third pivot centerlines C3 and a plurality of fourth pivot centerlines C4 alternately arranged in the extending direction (Z-axis direction) of the chain 10.

As described above, in the case of the first embodiment, the plurality of second links 30 have the same shape, and the third and fourth pivot centerlines C3 and C4 are substantially orthogonal as viewed in the extending direction (Z-axis direction) of the chain 10. Therefore, as illustrated in FIG. 5A, four consecutive second links 30 correspond to one cycle of the second helical link linkage 50. In addition, the four consecutive second links 30, that is, the second helical link linkage 50 have a substantially square contour as viewed in the extending direction (Z-axis direction) of the chain 10, as illustrated in FIG. 5B.

The first helical link linkage 40 formed of the plurality of first links 20 and the second helical link linkage 50 formed of the plurality of second links 30 are linked by linking members to form a chain 10. Specifically, the first helical link linkage 40 and the second helical link linkage 50 are linked to form a double helix structure.

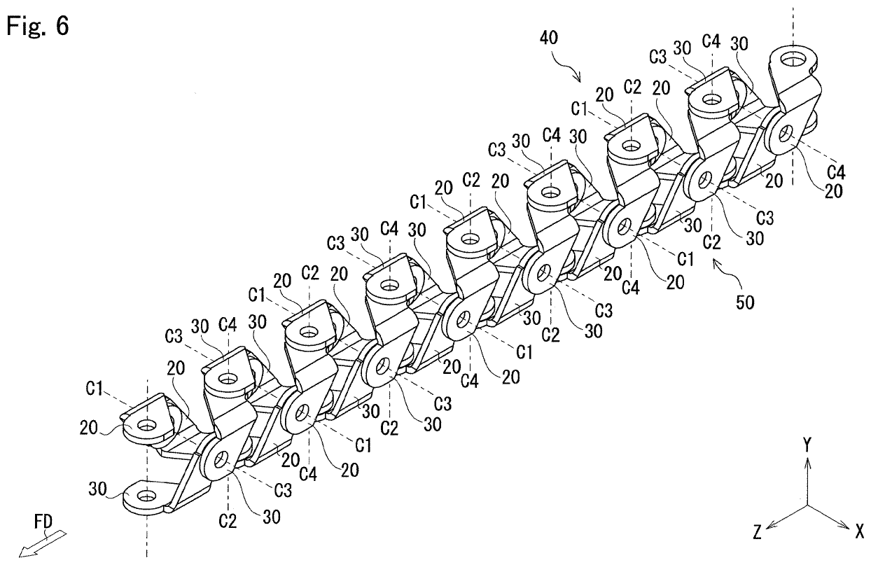

FIG. 6 is a perspective view illustrating first and second helical link linkages forming a double helix structure.

As illustrated in FIG. 6, the first helical link linkage 40 and the second helical link linkage 50 form a double helix structure without direct contact with each other.

Specifically, each of the first pivot centerlines C1 of the first links 20 forming the first helical link linkage 40 and a corresponding one of the third pivot centerlines C3 of the second links 30 forming the second helical link linkage 50 are located on the same straight line. In addition, each of the second pivot centerlines C2 of the first links 20 and a corresponding one of the fourth pivot centerlines C4 of the second links 30 are located on the same straight line. As a result, the first helical link linkage 40 and the second helical link linkage 50 form a double helix structure without direct contact with each other. Strictly speaking, it is sufficient that the first helical link linkage 40 and the second helical link linkage 50 are not in direct contact with each other at least when the chain 10 extends linearly. This is because the chain 10 cannot be bent otherwise.

Such linking of the first helical link linkage 40 and the second helical link linkage 50 is performed via linking members.

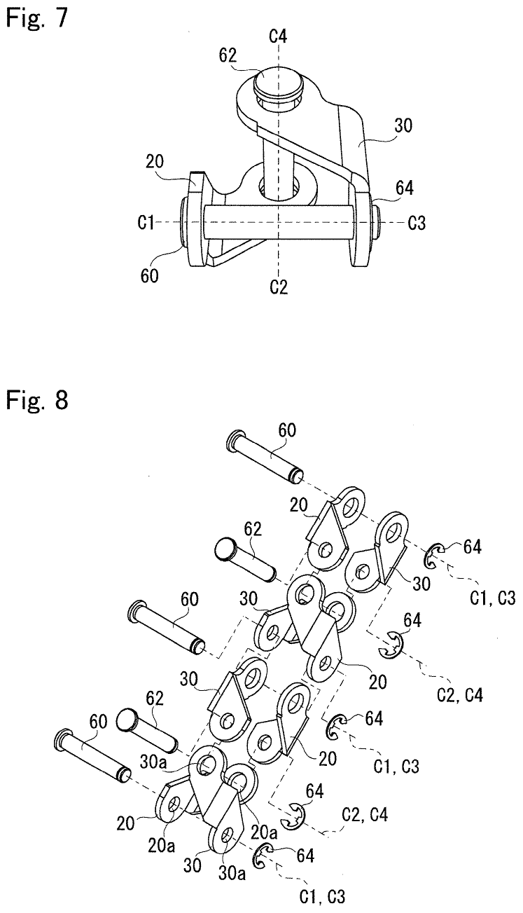

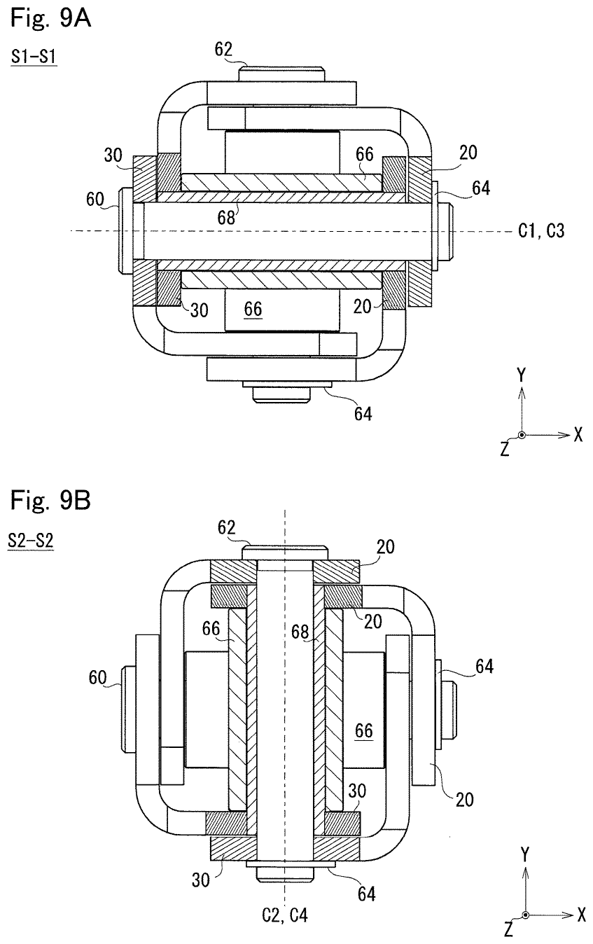

FIG. 7 is a perspective view illustrating the first and second links in a state of being linked via linking members. FIG. 8 is an exploded perspective view for describing linking of a plurality of first and second links via a plurality of linking members. FIG. 9A is a cross-sectional view of the chain taken along line S1-S1 illustrated in FIG. 1. FIG. 9B is a cross-sectional view of the chain taken along line S2-S2 illustrated in FIG. 1.

As illustrated in FIGS. 7 to 9B, in the case of the first embodiment, the chain 10 includes first and second pins 60, 62 as linking members. Via the first and second pins 60, 62, the first links 20 in the first helical link linkage 40 and the second links 30 in the second helical link linkage 50 are linked.

A first pin 60 pivotally supports the second links 30 while pivotally supporting the first links 20. Specifically, the first pin 60 supports the first links 20 pivotally about the first pivot centerline C1 on one of the base end and the tip end. In addition, the first pin 60 supports the second links 30 pivotally about the third pivot centerline C3 on the other of the base end and the tip end. With such support with the first pin 60, the first pivot centerline C1 of the first links 20 and the third pivot centerline C3 of the second links 30 are located on the same straight line.

The first pin 60 pivotally supports each of the two consecutive first links 20 pivotally about the first pivot centerline C1. Thereby, the two consecutive first links 20 are linked pivotally with respect to each other about the first pivot centerline C1. At the same time, the first pin 60 supports each of the two consecutive second links 30 pivotally about the third pivot centerline C3. Thereby, the two consecutive second links 30 are linked pivotally with respect to each other about the third pivot centerline C3. In other words, the first pin 60 pivotally supports the two first links 20 and the two second links 30.

A second pin 62 also pivotally supports the second links 30 while pivotally supporting the first links 20. Specifically, the second pin 62 pivotally supports the first links 20 about the second pivot centerline C2 on one of the base end and the tip end. In addition, the second pin 62 pivotally supports the second links 30 about the fourth pivot centerline C4 on the other of the second base end and the tip end. With such support with the second pin 62, the second pivot centerline C2 of the first links 20 and the fourth pivot centerline C4 of the second links 30 are located on the same straight line.

The second pin 62 supports each of the two consecutive first links 20 pivotally about the second pivot centerline C2. Thereby, the two consecutive first links 20 are linked pivotally with respect to each other about the second pivot centerline C2. At the same time, the second pin 62 supports each of the two consecutive second links 30 pivotally about the fourth pivot centerline C4. Thereby, the two consecutive second links 30 are linked pivotally with respect to each other about the fourth pivot centerline C4. In other words, the second pin 62 pivotally supports the two first links 20 and the two second links 30.

In the case of the first embodiment, first and second pins 60, 62 have the same shape.

In the case of the first embodiment, the first and second links 20, 30 are pivotally supported by the first and second pins 60, 62. Therefore, as illustrated in FIG. 8, each first link 20 has two through holes 20a and each second link 30 has two through holes 30a. The two through holes 20a have a first pin 60 and a second pin 62 inserted therethrough, and the two through holes 30a have a first pin 60 and a second pin 62 inserted therethrough. In each first link 20, one through hole 20a penetrates in the extending direction of the first pivot centerline C1, and the other through hole 20a penetrates in the extending direction of the second pivot centerline C2. In each second link 30, one through hole 30a penetrates in the extending direction of the third pivot centerline C3, and the other through hole 30a penetrates in the extending direction of the fourth pivot centerline C4. The first pins 60 and the second pins 62 are inserted into the through holes 20a. This causes each first pin 60 to support the first link 20 pivotally about the first pivot centerline C1, and causes each second pin 62 to support the first link 20 pivotally about the second pivot centerline C2. Likewise, the first pins 60 and the second pins 62 are Inserted into the through holes 30a. This causes each first pin 60 to support the second link 30 pivotally about the third pivot centerline C3, and causes each second pin 62 to support the second link 30 pivotally about the fourth pivot centerline C4.

Note that a snap ring 64 is attached to the tip end of each of the first and second pins 60, 62. This prevents the first and second pins 60, 62 from falling off the first and second links 20, 30. In the case of the first embodiment, as illustrated in FIGS. 9A and 9B, a roller 66 is attached to each of the first and second pins 60, 62 via a bush 68. The roller 66 and the bush 68 both may be provided or they both may be omitted, as necessary. Alternatively, only the roller 66 may be provided as necessary.

Furthermore, the way of retaining the first and second pins 60, 62 in the first and second links 20, 30 is not limited to use of the snap rings 64, and for example, split pins or the like may be used instead. Furthermore, the first and second pins 60, 62 and the first and second links 20, 30 may be combined by, for example, swaging so that other parts are not used.

In the first embodiment, each of the plurality of first and second pins 60, 62 pivotally supports two first links 20 and two second links 30. Alternatively, the first and second pins 60, 62 may be provided integrally with the first links 20 and the second links 30.

As illustrated in FIGS. 9A and 9B, each first link 20 has an inner portion placed inside with respect to an adjacent first link 20 linked to one side, and has an outer portion placed outside with respect to another adjacent first link 20 linked to the other side. Likewise, each second link 30 has an inner portion placed inside with respect to an adjacent second link 30 linked to one side, and has an outer portion placed outside with respect to another adjacent second link 30 linked to the other side. For example, there may be a configuration such that: a bush 68 is integrally provided on each of the inner portions of the first links 20 and the inner portions of the second links 30; and each of the first and second pins 60, 62 passes through a corresponding one of bushes 68, and is integrally provided on a corresponding one of the outer portions of the first links 20 and the outer portions of the second links 30. In other words, in a state in which each bush 68 is non-pivotally supported by a corresponding one of the inner portions of the first and second links 20, 30, the bush 68 pivotally supports a corresponding one of the first and second pins 60, 62 that is non-pivotally supported by a corresponding one of the outer portions of the first and second links 20, 30.

The method for integrally providing each of the first and second pins 60, 62 to a corresponding one of the first and second links 20, 30 is “interference fit”, for example. Briefly describing an “interference fit”, first through holes are provided in each of the first and second links 20, 30. The first and second pins 60, 62 are each press-fitted into a corresponding one of the through holes. As a result, the first and second pins 60, 62 are each non-pivotally supported by the through hole.

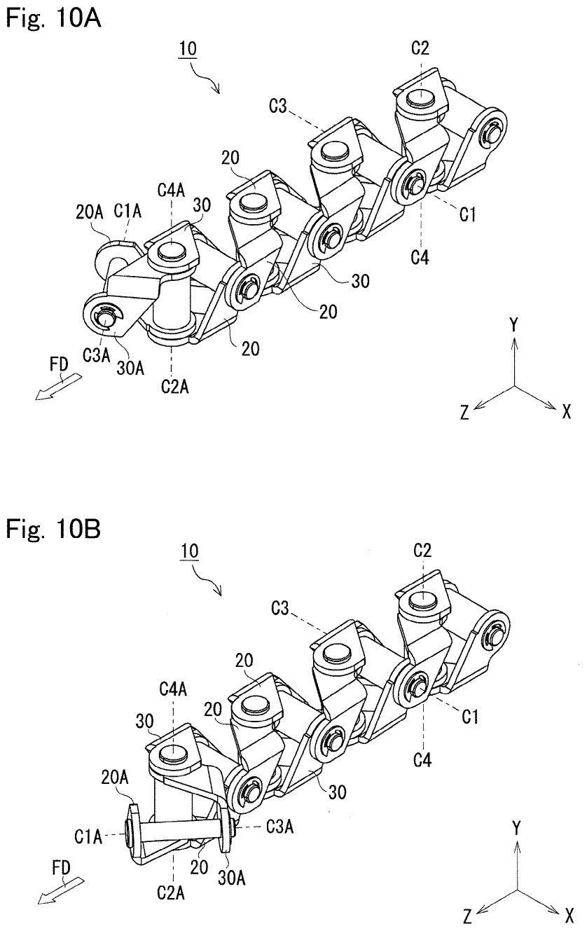

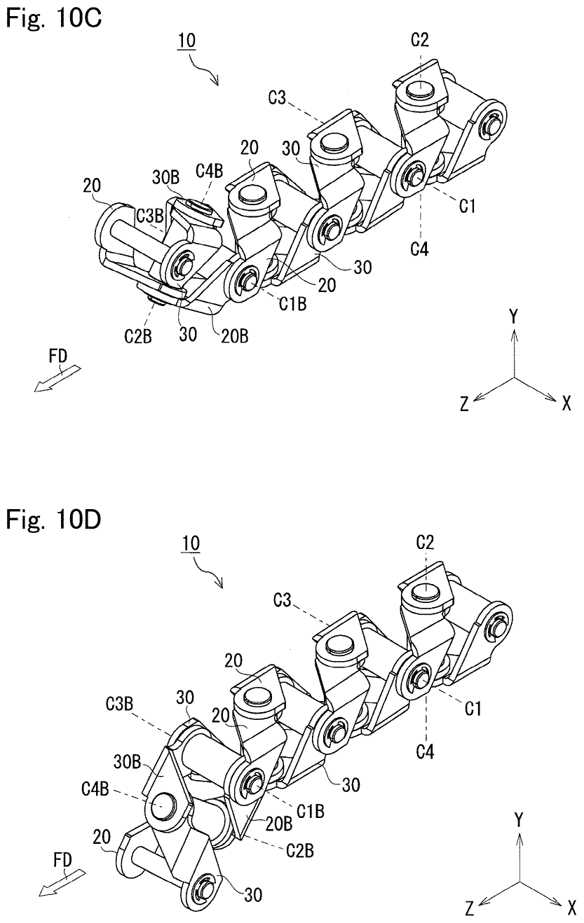

FIGS. 10A to 10D are perspective views illustrating a part of the chain bending in different directions.

As illustrated in FIGS. 10A and 10B, when a first link 20 (20A) pivots about the second pivot centerline C2 (C2A) to one side or the other side in the width direction (X-axis direction), the corresponding second link 30 (30A) pivots about the fourth pivot centerline C4 (C4A) located on the same straight line as the second pivot centerline C2 (C2A) in the same direction.

Note that, in the present description, when there are a first link and a second link, and the relative position of one with respect to the other is maintained substantially constant, that is, when the one cannot move relative to the other, the case is defined as that there is a “correspondence relationship” between these first link and second link. In the case of the first embodiment, as illustrated in FIG. 7, the first link 20 and the second link 30 supported by the common first and second pins 60, 62 are in a correspondence relationship.

As illustrated in FIGS. 10C and 10D, when a first link 20 (20B) pivots about the first pivot centerline C1 (C1B) to one side or the other side in the thickness direction (Y-axis direction), the corresponding second link 30 (30B) pivots about the third pivot centerline C3 (C3B) located on the same straight line as the first pivot centerline C1 (C1B).

As described above, the first link 20 and the corresponding second link 30 pivot in synchronization with each other, thereby the chain 10 can be bent in the width direction (X-axis direction) and the thickness direction (Y-axis direction) as viewed in the extending direction (Z-axis direction). In other words, in the case of the first embodiment, the chain 10 can be bent in four directions as viewed in the extending direction thereof. As a result, the chain 10 can freely change the traveling direction. As a result, the chain 10 can move along complex paths that turn in complex ways, as well as straight paths.

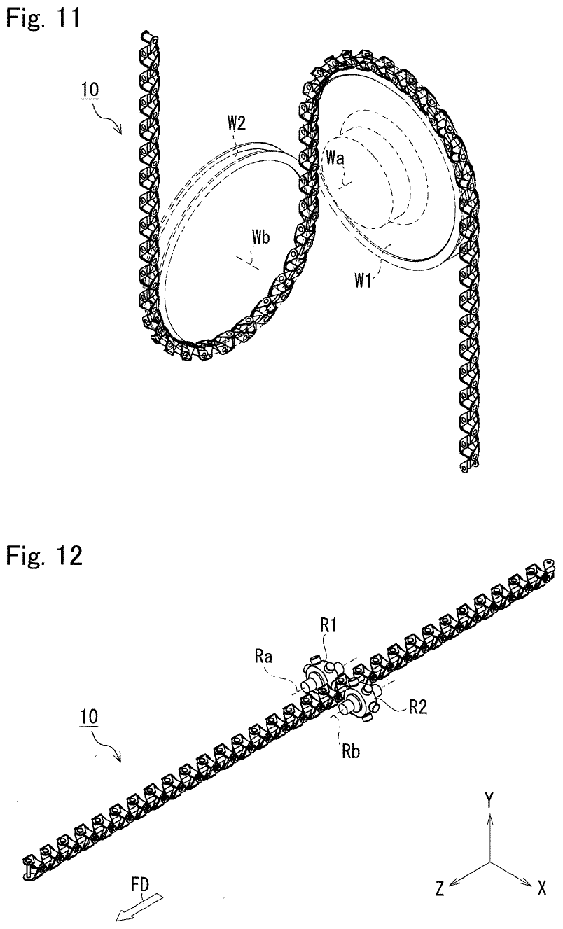

FIG. 11 is a perspective view illustrating the chain according to the first embodiment in a state of being engaged with a plurality of sprockets. In FIG. 11, the teeth of the sprockets W1, W2 are omitted.

As illustrated in FIG. 11, the chain 10 may move along a path with various turns. As a result, for example, the chain 10 can engage with the plurality of sprockets W1, W2 having different extending directions of the rotation centerlines Wa, Wb. As illustrated in FIG. 2, the teeth of the sprockets W1, W2 can be engaged with the chain 10 by entering the gaps G each formed between the first link 20 and the second link 30. In other words, the teeth of the sprockets W1, W2 come into contact with the first links 20 and the second links 30 in the extending direction (Z-axis direction) of the chain 10, so that the chain 10 can be driven in the extending direction.

According to the chain 10 of the first embodiment, the sprockets W1, W2 can engage with the chain 10 in the width direction (X-axis direction) of the chain 10 and also in the thickness direction (Y-axis direction) thereof. This is because the first link 20 and the second link 30 engaging with the teeth of the sprockets W1, W2 form the first and second helical link linkages 40, 50. As a result, the sprockets W1, W2 can engage with the chain 10 from four directions as viewed in the extending direction (Z-axis direction) of the chain 10.

As in the chain 10 according to the first embodiment, a belt, a wire, or the like is used as a power transmission member that can freely change the traveling direction in order to move along a complex path. However, since the belt and the wire are easily twisted unlike the chain, the power transmission efficiency is lower than that of the chain. In addition, when the pulleys are freely placed like the sprockets W1, W2 illustrated in FIG. 11, the belt or the wire is likely to engage with the pulleys with insufficient tensions and to slip on the pulleys. Therefore, the chain 10 according to the first embodiment can move along a complex path as in a belt or a wire, and has higher power transmission efficiency than a belt or a wire.

In addition, since the chain 10 is less likely to twist than a belt or a wire, various options can be attached to the chain 10. For example, the first link 20 (and/or the second link 30) of the chain 10 may be integrally or removably provided with an attachment for attaching other members to the chain 10. For example, the chain 10 may be provided with a plastic cover.

Furthermore, in the chain 10 of the first embodiment, the first helical link linkage 40 including the plurality of first links 20 and the second helical link linkage 50 including the plurality of second links 30 form a double helix structure as illustrated in FIG. 6. In other words, the first and second helical link linkages 40, 50 are like threads of so-called a double-thread screw. Therefore, the first and second helical link linkages 40, 50 can drive various rotating bodies, and also can be driven by various rotating bodies.

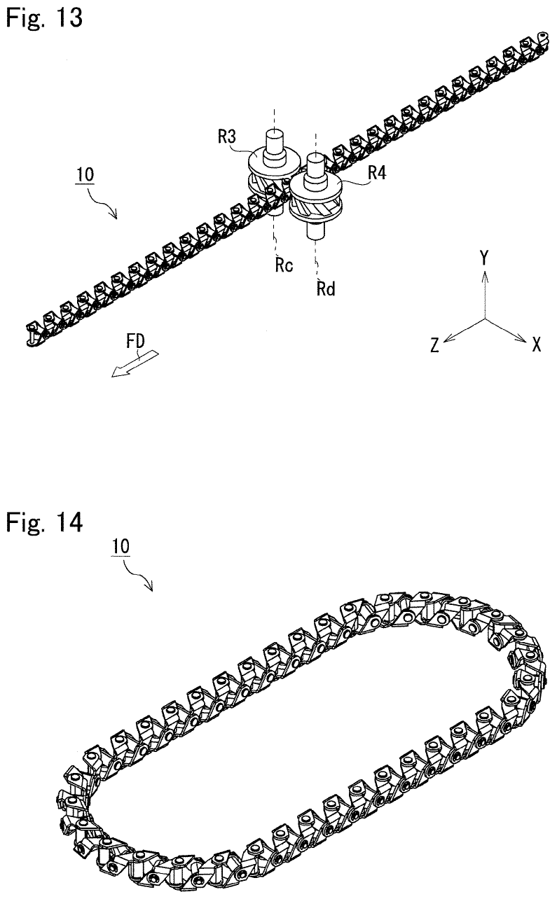

FIG. 12 is a perspective view illustrating a chain according to the first embodiment and a rotating body of an example. FIG. 13 is a perspective view illustrating a chain according to the first embodiment and another example of rotating bodies.

As illustrated in FIG. 12, the chain 10 can engage with rotating bodies R1, R2 respectively including rotation centerlines Ra, Rb extending in the extending direction (Z-axis direction) of the chain. The rotating bodies R1, R2 include rollers, teeth, and the like that enter the gap G between the first link 20 and the second link 30 of the chain 10. The rotating bodies R1, R2 face each other in the width direction (X-axis direction) of the chain 10 with the chain 10 interposed therebetween. As a result, when the chain 10 moves in its extending direction (Z-axis direction), the rotating bodies R1, R2 are driven to rotate. Conversely, when the rotating bodies R1, R2 rotate in directions opposite to each other, the chain 10 is driven in the extending direction thereof.

In addition, as illustrated in FIG. 13, the chain 10 can engage with rotating bodies R3, R4 respectively including rotation centerlines Rc, Rd extending in a direction orthogonal to the extending direction (Z-axis direction) of the chain 10. The respective rotation centerlines Rc, Rd of the rotating bodies R3, R4 illustrated in FIG. 13 extend in the thickness direction (Y-axis direction) of the chain 10. In addition, the rotating bodies R3, R4 include teeth or the like that enter the gaps G between the first links 20 and the second links 30 of the chain 10. The rotating bodies R3, R4 face each other in the width direction (X-axis direction) of the chain 10 with the chain 10 interposed therebetween. As a result, when the chain 10 moves in its extending direction (Z-axis direction), the rotating bodies R3, R4 are driven to rotate. Conversely, when the rotating bodies R3, R4 rotate in directions opposite to each other, the chain 10 is driven in the extending direction thereof.

The chain 10 is not limited to having ends, and may be endless.

FIG. 14 is a perspective view of the endless chain according to the first embodiment.

As illustrated in FIG. 14, the chain 10 may be endless depending on its application. The chain 10 can be used in various applications by taking a form having ends or an endless form, thereby providing high versatility.

According to the first embodiment as described above, the chain 10 that can be bent in a plurality of directions as viewed in the extending direction can have a highly versatile structure that can be used as it is.

### Second Embodiment

A second embodiment is substantially the same as the first embodiment described above except that the shapes of the first and second links are different. The second embodiment is almost the same as the first embodiment except for the above. Therefore, the second embodiment is described focusing on different points.

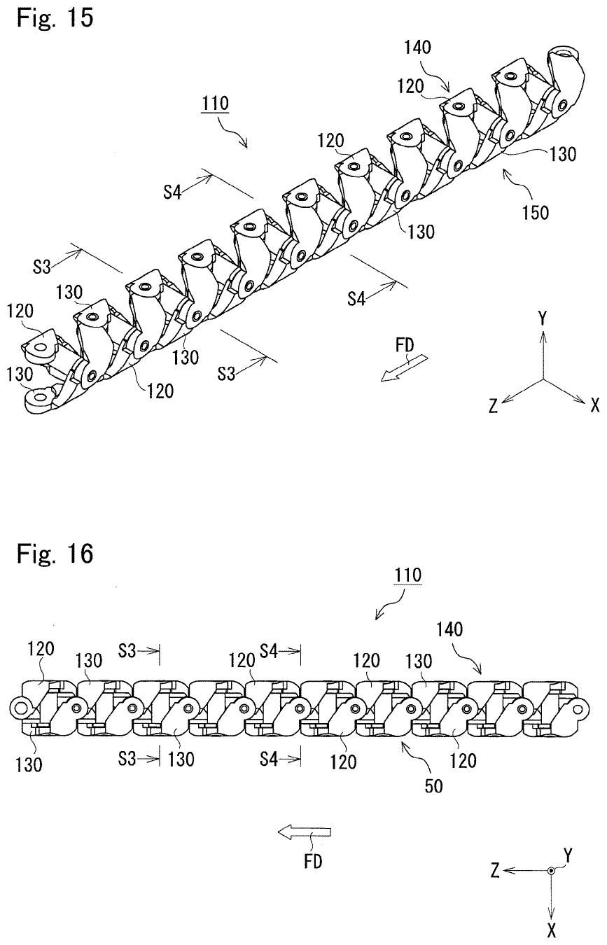

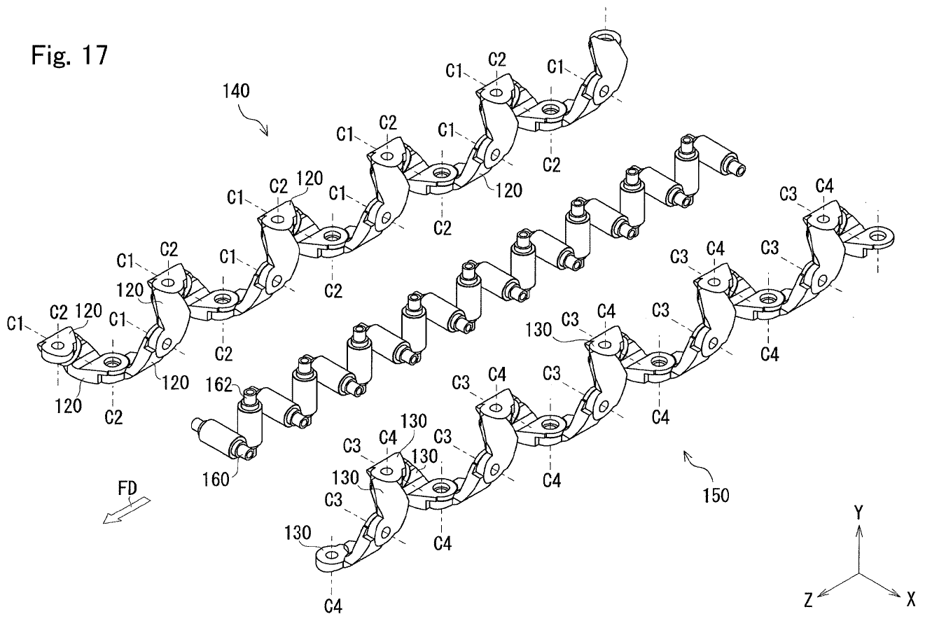

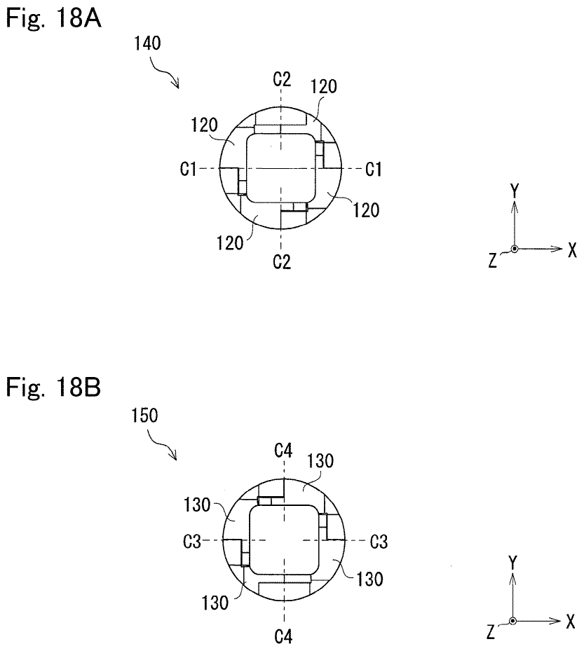

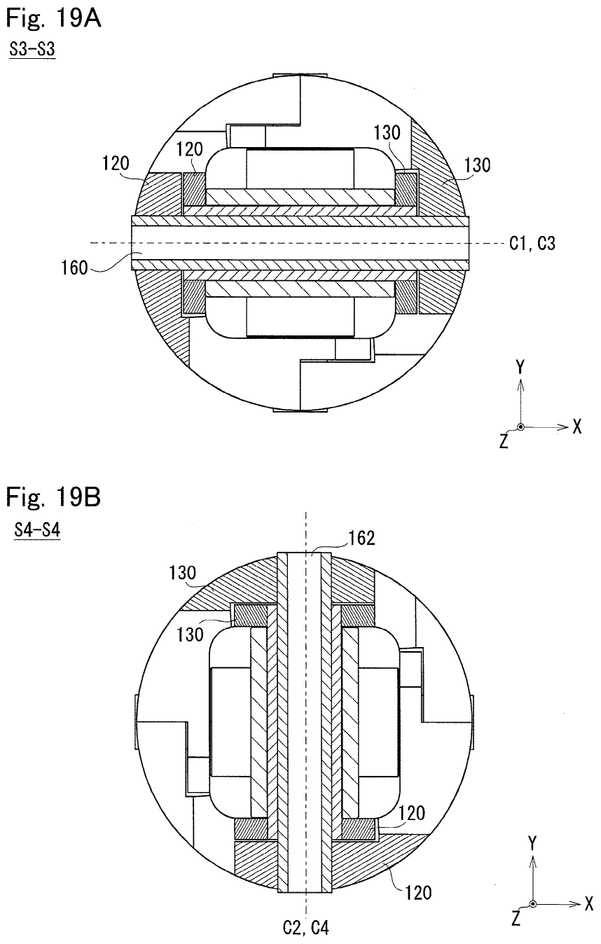

FIG. 15 is a perspective view of a part of a chain according to the second embodiment. FIG. 16 is a top view of a part of the chain according to the second embodiment. FIG. 17 is an exploded perspective view of a part of the chain according to the second embodiment. FIG. 18A is a front view of a plurality of first links linked to each other (first helical link linkage), and FIG. 18B is a front view of a plurality of second links linked to each other (second helical link linkage). FIGS. 19A and 19B are respectively a cross-sectional view of the chain taken along line S3-S3 and a cross-sectional view of the chain taken along line S4-S4, illustrated in FIG. 15.

As illustrated in FIGS. 15 to 19B, in the chain 110 according to the second embodiment, a plurality of first links 120 forming a first helical link linkage 140 have the same shape. In addition, a plurality of second links 130 forming a second helical link linkage 150 have the same shape. In addition, in the case of the second embodiment, the first links 120 and the second links 130 have the same shape. In other words, the chain 110 according to the second embodiment is formed of one type of links.

As illustrated in FIGS. 18A and 18B, the first links 120 and the second links 130 each have an are shape as viewed in the extending direction (Z-axis direction) of the chain 10. As a result, the first and second helical link linkages 140, 150 each have a substantially circular shape as viewed in the extending direction of the chain 110.

As illustrated in FIGS. 19A and 19B, the first links 120 and the second links 130 are linked to and supported by the first and second pins 160, 162 such that each first pivot centerline C1 and the corresponding third pivot centerline C3 are located on the same straight line, and each second pivot centerline C2 and the corresponding fourth pivot centerline C4 are located on the same straight line.

Similarly to the first embodiment described above, also in the second embodiment, the chain 110 that can be bent in a plurality of directions as viewed in the extending direction can have a highly versatile structure that can be used as it is.

In the case of the second embodiment, as illustrated in FIGS. 19A and 19B, the chain 110 has a circular shape as viewed in the extending direction (Z-axis direction), and thus is suitable for movement in a circular tube.

### Third Embodiment

In the case of the above-described first embodiment, as illustrated in FIG. 3, the plurality of first links 20 forming the first helical link linkage 40 are of one type. In addition, also the plurality of second links 30 forming the second helical link linkage 50 are of one type. In contrast, in a third embodiment, a plurality of first links forming a first helical link linkage include a plurality of types of links having different shapes, and a plurality of second links forming a second helical link linkage include a plurality of types of links having different shapes. The third embodiment is almost the same as the first embodiment except for the above. Therefore, the third embodiment is described focusing on this different point.

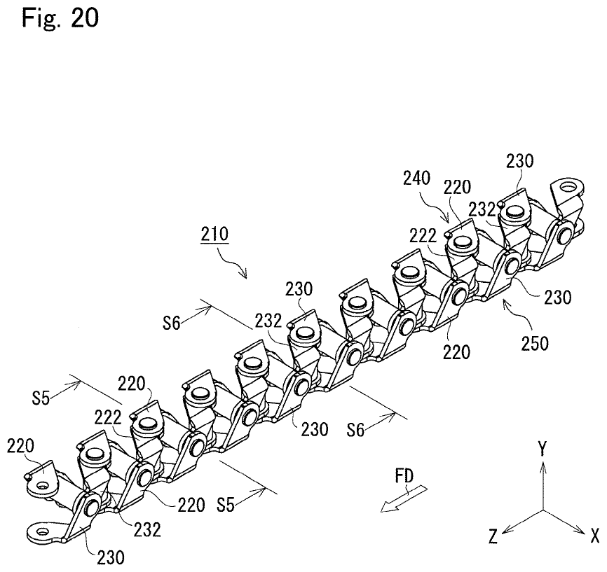

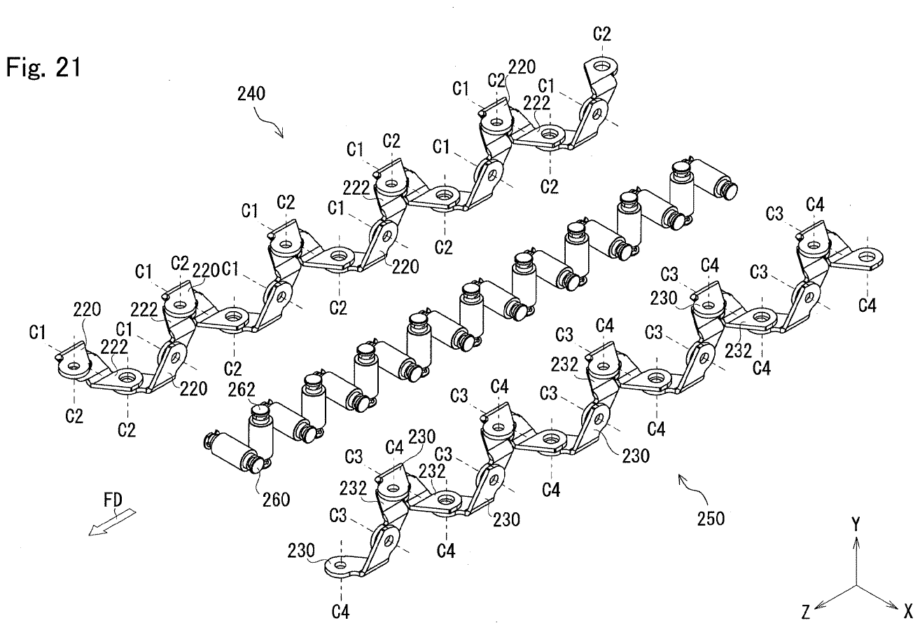

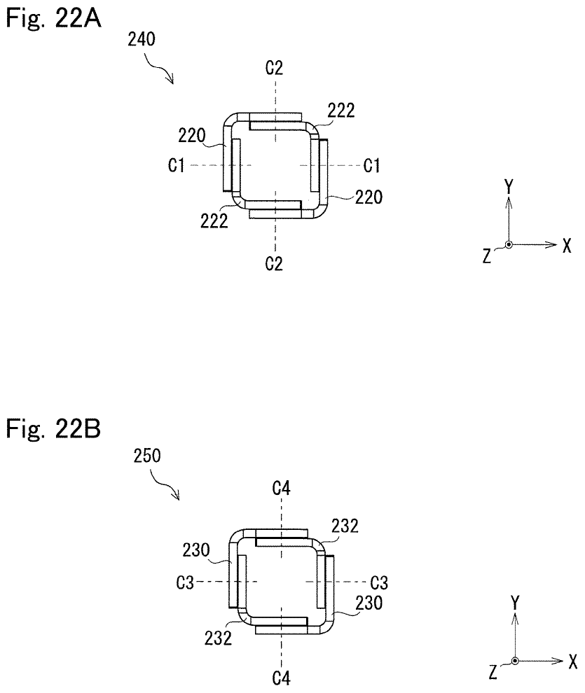

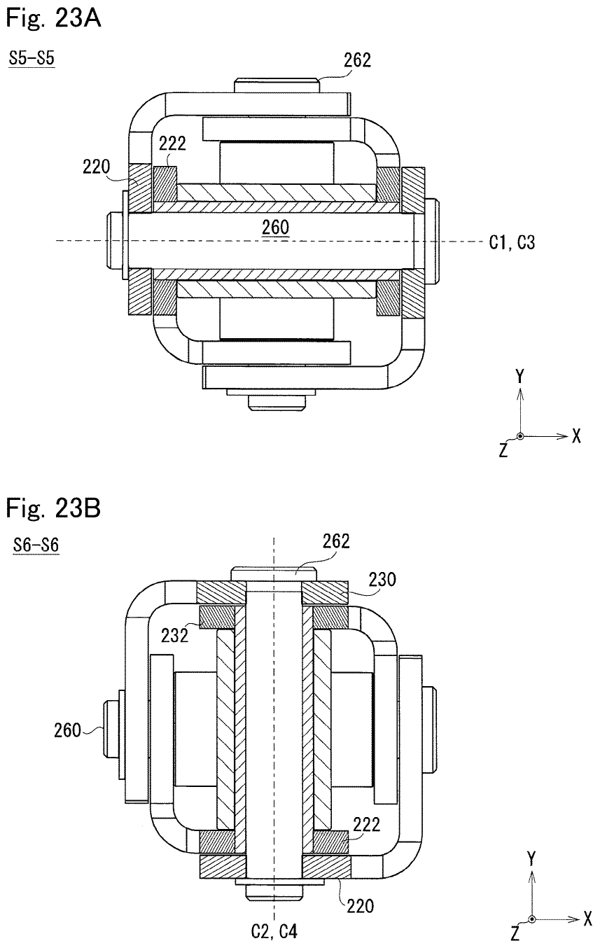

FIG. 20 is a perspective view of a part of a chain according to the third embodiment. FIG. 21 is an exploded perspective view of a part of the chain according to the third embodiment. FIG. 22A is a front view of a plurality of first links linked to each other (first helical link linkage), and FIG. 22B is a front view of a plurality of second links linked to each other (second helical link linkage). FIG. 23A and FIG. 23B are respectively a cross-sectional view of the chain taken along line S5-S5 illustrated in FIG. 20 and a cross-sectional view of the chain taken along line S6-S6 illustrated in FIG. 20.

As illustrated in FIGS. 20 to 23B, in the chain 210 according to the third embodiment, the first helical link linkage 240 is formed of a plurality of types of first links 220, 222 having different shapes. The second helical link linkage 250 is formed of a plurality of types of second links 230, 232 having different shapes.

Specifically, as illustrated in FIGS. 21 and 22A, each first link 222 is smaller than the first link 220. The relatively small first links 222 are entirely placed inside the first links 220. In addition, the first links 220, 222 are linked alternately to form a first helical link linkage 240.

Likewise, as illustrated in FIGS. 21 and 22B, each second link 232 is smaller than the second link 230. The relatively small second links 232 are entirely placed inside the second links 230. In addition, the second links 230, 232 are linked alternately to form a second helical link linkage 250.

In the case of the third embodiment, the first links 220 and the second links 230 have the same shape, and the first links 222 and the second links 232 have the same shape. In other words, the chain 210 of the third embodiment includes two types of links.

As illustrated in FIGS. 23A and 23B, the first links 220, 222 and the second links 230, 232 are linked to and supported by the first and second pins 260, 262 such that each first pivot centerline C1 and the corresponding third pivot centerline C3 are located on the same straight line, and each second pivot centerline C2 and the corresponding fourth pivot centerline C4 are located on the same straight line.

Similarly to the first embodiment described above, also in the third embodiment, the chain 210 that can be bent in a plurality of directions as viewed in the extending direction can have a highly versatile structure that can be used as it is.

### Fourth Embodiment

In the case of the above-described third embodiment, as illustrated in FIGS. 23A and 23B, the size in the width direction (X-axis direction) and the size in the thickness direction (Y-axis direction) of the cross section of the chain 210 are substantially the same. To make it so, the shapes of the first links 220, 222 and the second links 230, 232 are determined. Therefore, the chain 210 according to the third embodiment described above can be used without distinction between the width direction and the thickness direction. In contrast, the cross section of a chain according to a fourth embodiment has a size in the width direction different from a size in the thickness direction. The fourth embodiment is almost the same as the third embodiment except for the above. Therefore, the fourth embodiment is described focusing on this different point.

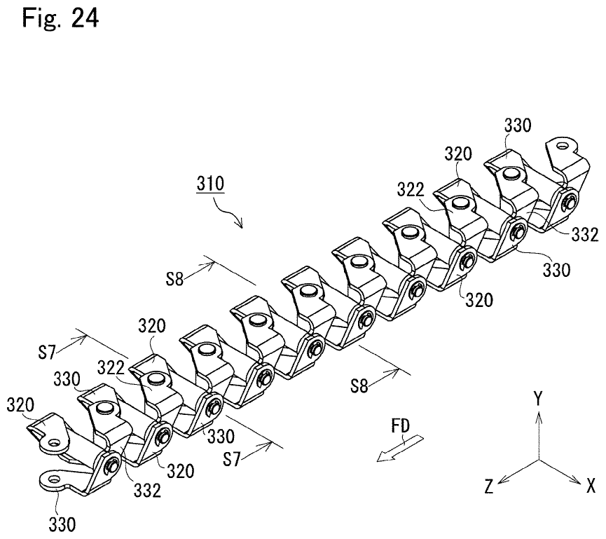

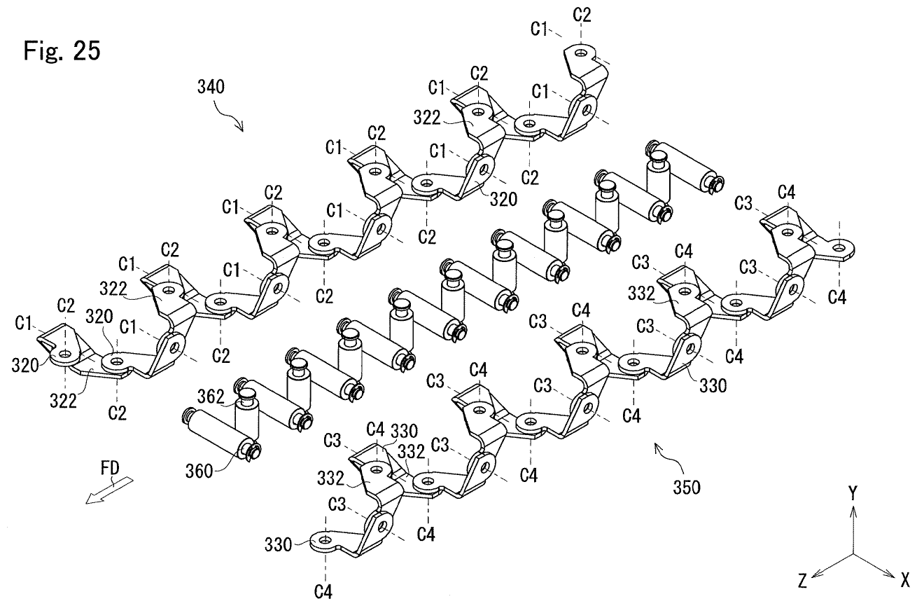

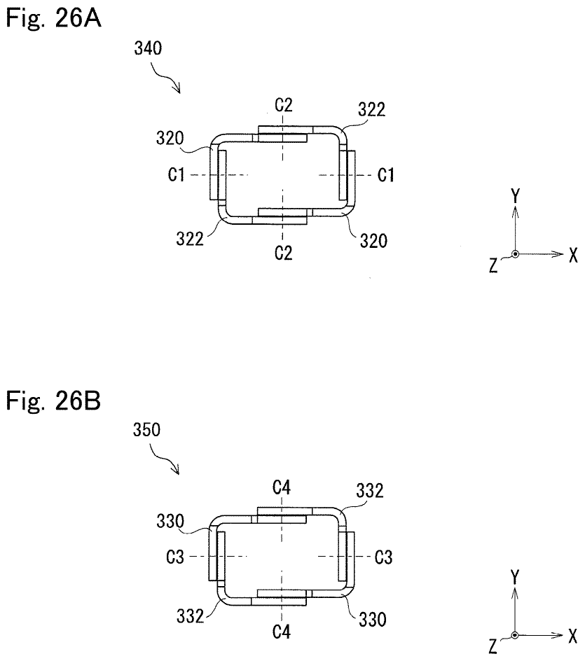

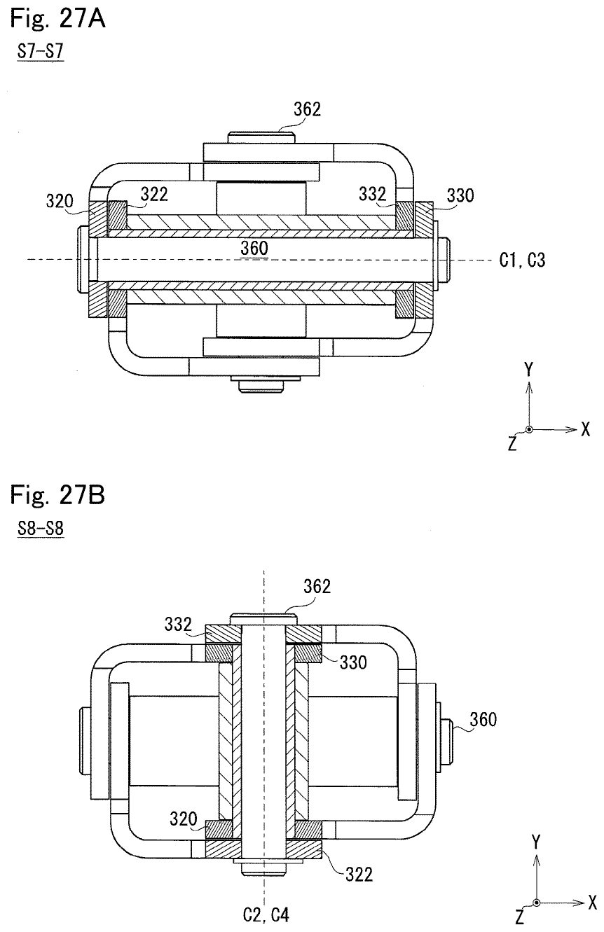

FIG. 24 is a perspective view of a part of the chain according to a fourth embodiment. FIG. 25 is an exploded perspective view of a part of the chain according to the fourth embodiment. FIG. 26A is a front view of a plurality of first links linked to each other (first helical link linkage), and FIG. 26B is a front view of a plurality of second links linked to each other (second helical link linkage). FIG. 27A is a cross-sectional view of the chain taken along line S7-S7 illustrated in FIG. 24, and FIG. 27B is a cross-sectional view of the chain taken along line S8-S8 illustrated in FIG. 24.

As illustrated in FIGS. 24 to 27B, in the chain 310 according to the fourth embodiment, the first helical link linkage 340 is formed of a plurality of types of first links 320, 322 having different shapes. The second helical link linkage 350 is formed of a plurality of types of second links 330, 332 having different shapes.

Specifically, as illustrated in FIGS. 27A and 27B, the shapes of the first links 320, 322 and the second links 330, 332 are determined such that the size in the width direction (X-axis direction) is larger than the size in the thickness direction (Y-axis direction) in the cross-sectional shape of the chain 310. Specifically, each of the first links 320 and 322 and the second links 330 and 332 has an L-shape having a size in the width direction larger than a size in the thickness direction.

In the case of the fourth embodiment, the first links 320 and the second links 330 have the same shape, and the first links 322 and the second links 332 have the same shape. In other words, the chain 310 of the fourth embodiment includes two types of links.

Such first links 320, 322 are alternately linked, as illustrated in FIG. 26A, thereby forming a first helical link linkage 340 that has a rectangular shape as viewed in the extending direction (Z-axis direction) of the chain 310. Such second links 330, 332 are alternately linked, as illustrated in FIG. 26B, thereby forming a second helical link linkage 350 that has a rectangular shape as viewed in the extending direction (Z-axis direction) of the chain 310.

As illustrated in FIGS. 27A and 27B, the first links 320, 322 and the second links 330, 332 are linked to and supported by the first and second pins 360, 362 such that each first pivot centerline C1 and the corresponding third pivot centerline C3 are located on the same straight line, and each second pivot centerline C2 and the corresponding fourth pivot centerline C4 are located on the same straight line.

Similarly to the first embodiment described above, also in the fourth embodiment, the chain 310 that can be bent in a plurality of directions as viewed in the extending direction can have a highly versatile structure that can be used as it is.

### Fifth Embodiment

In the case of the above-described first embodiment, as illustrated in FIG. 4B, each of the plurality of first links 20 includes a first pivot centerline C1 and a second pivot centerline orthogonal to each other. As illustrated in FIG. 5B, each of the plurality of second links 30 includes a third pivot centerline C3 and a fourth pivot centerline C4 orthogonal to each other. In contrast, in a chain according to the sixth embodiment, the first and second pivot centerlines in each of the first links cross at an angle different from 90 degrees, and the third and fourth pivot centerlines in each of the second links also cross at an angle different from 90 degrees. The fifth embodiment is almost the same as the first embodiment except for the above. Therefore, the fifth embodiment is described focusing on this different point.

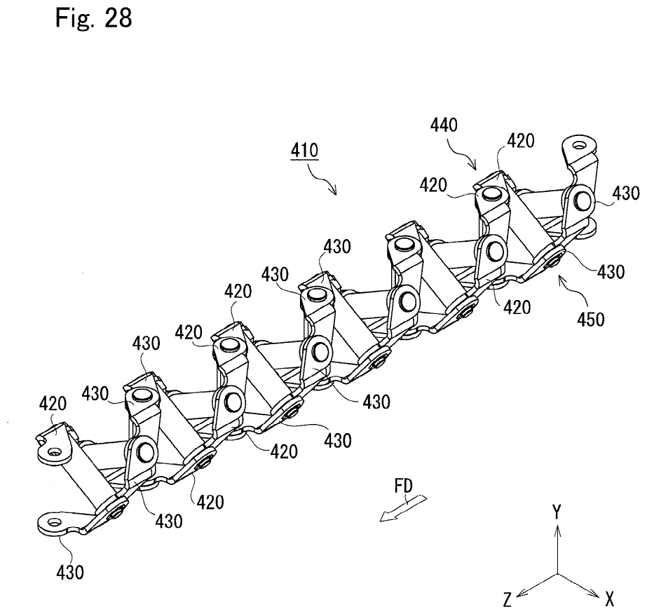

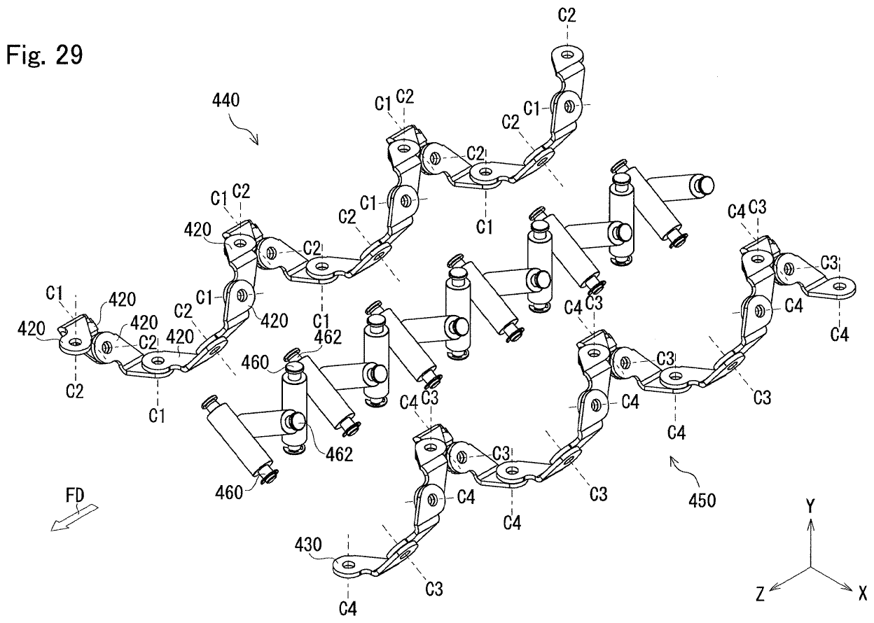

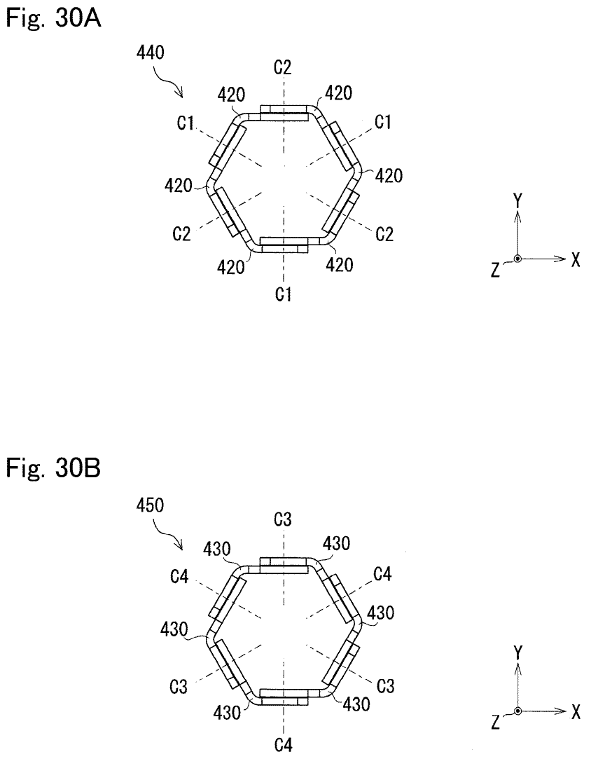

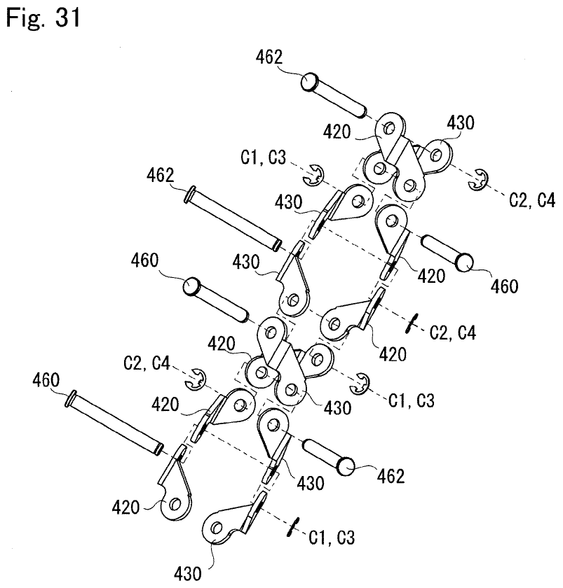

FIG. 28 is a perspective view of a part of a chain according to the fifth embodiment. FIG. 29 is an exploded perspective view of a part of the chain according to the fifth embodiment. FIG. 30A is a front view of a plurality of first links linked to each other (first helical link linkage), and FIG. 30B is a front view of a plurality of second links linked to each other (second helical link linkage). FIG. 31 is an exploded perspective view for describing linking of the plurality of first and second links via the plurality of linking members.

As illustrated in FIGS. 28 to 31, the chain 410 according to the fifth embodiment has a first helical link linkage 440 that is formed by linking a plurality of first links 420 having the same shape. The second helical link linkage 450 is formed by linking a plurality of second links 430 having the same shape. In the case of the fifth embodiment, the first and second links 420, 430 have the same shape. In other words, the chain 410 according to the fifth embodiment is formed of one type of links.

As illustrated in FIGS. 29 and 30A, each of the first links 420 pivots about the first and second pivot centerlines C1, C2. Specifically, each first link 420 is linked, on its one side, with an adjacent first link 420 and pivots with respect to the adjacent first link 420 about the first pivot centerline C1, while each first link 420 is linked, on its other side, with another adjacent first link 420 and pivots with respect to the other adjacent first link 420 about the second pivot centerline C2. In the case of the fifth embodiment, as illustrated in FIG. 30A, the first pivot centerline C1 and the second pivot centerline C2 cross at an angle of substantially 60 degrees as viewed in the extending direction (Z-axis direction) of the chain 410.

In such first links 420, six consecutive first links 420 correspond to one cycle of the first helical link linkage 440.

As illustrated in FIGS. 29 and 30B, each of the second links 430 rotates about the third and fourth pivot centerlines C3, C4. Specifically, each second link 430 is linked, on its one side, with an adjacent second link 430 and pivots with respect to the adjacent second link 430 about the third pivot centerline C3, while each second link 430 is linked, on its other side, with another adjacent second link 430 and pivots with respect to the other adjacent second link 430 about the fourth pivot centerline C4. In the case of the fifth embodiment, as illustrated in FIG. 30B, the third pivot centerline C3 and the fourth pivot centerline C4 cross at an angle of substantially 60 degrees as viewed in the extending direction (Z-axis direction) of the chain 410.

In such second links 430, six consecutive second links 430 correspond to one cycle of the second helical link linkage 450.

As illustrated in FIG. 31, the first links 420 and the second links 430 are linked to and supported by the first and second pins 460, 462 such that each first pivot centerline C1 and the corresponding third pivot centerline C3 are located on the same straight line, and each second pivot centerline C2 and the corresponding fourth pivot centerline C4 are located on the same straight line.

Similarly to the first embodiment described above, also in the fifth embodiment, the chain 410 that can be bent in a plurality of directions as viewed in the extending direction can have a highly versatile structure that can be used as it is.

In the case of the fifth embodiment, the chain 410 can be bent in six directions as viewed in the extending direction (Z-axis direction) of the chain 410. The sprocket can engage with the chain 410 from the six directions.

To supplement, the angle at which the first pivot centerline crosses the second pivot centerline and the angle at which the third pivot centerline crosses the fourth pivot centerline are not limited to 90 degrees or 60 degrees, and may be any angle as viewed in the extending direction of the chain. However, these angles are preferably such that a value obtained by multiplying these angles by an integer is 360 degrees. In other words, one cycle of the first helical link linkage is preferably formed by an integer number of the first links, and one cycle of the second helical link linkage is preferably formed by an integer number of the second links. As a result, productivity and handleability of the chain are improved. For example, the chain can be easily made endless, as illustrated in FIG. 14.

### Sixth Embodiment

In the case of the above-described first embodiment, the first helical link linkage 40 and the second helical link linkage 50 are linked by a plurality of first and second pins 60, 62. Therefore, as illustrated in FIG. 7, a first link 20 and a second link 30 corresponding to each other are linked by one first pin 60 and one second pin 62. In contrast, in the sixth embodiment, the first helical link structure and the second helical link structure are linked via linking members different from the pin. Therefore, a sixth embodiment is described focusing on the different linking members.

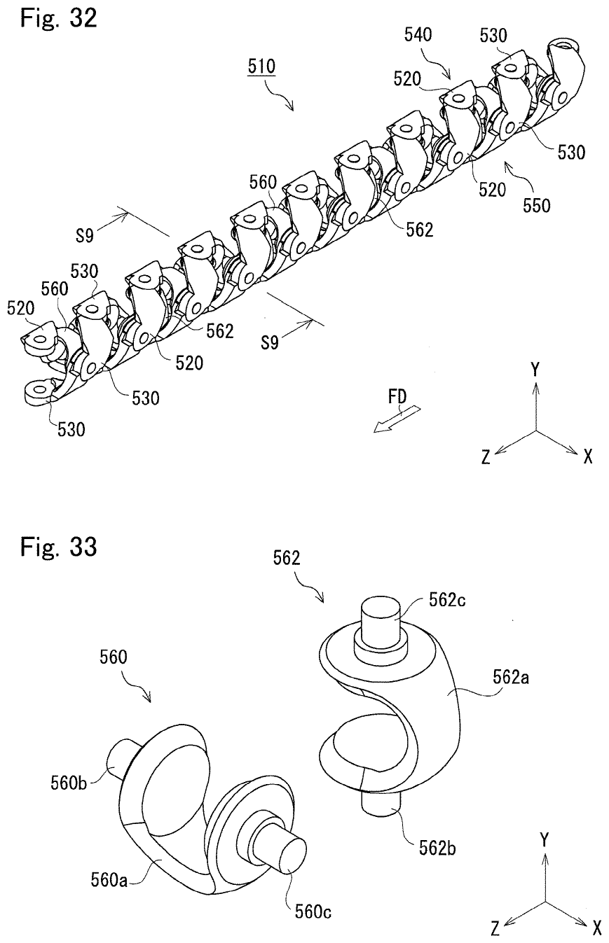

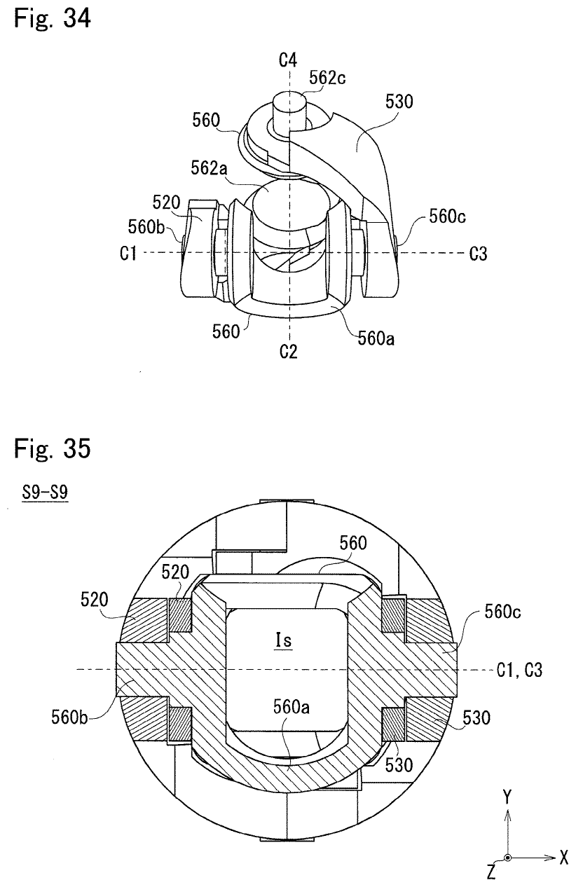

FIG. 32 is a perspective view of a part of a chain according to the sixth embodiment. FIG. 33 is a perspective view of first and second linking members in the chain according to the sixth embodiment. FIG. 34 is a perspective view illustrating the first and second links in a state of being linked via the linking members. FIG. 35 is a cross-sectional view of the chain taken along line S9-S9 illustrated in FIG. 32.

As illustrated in FIGS. 32 to 35, in the chain 510 according to the sixth embodiment, the first helical link linkage 540 and the second helical link linkage 550 are linked to each other via first and second joints 560 and 562.

As illustrated in FIG. 32, the first joint 560 is placed within the double helix structure formed by the first helical link linkage 540 and the second helical link linkage 550. As illustrated in FIG. 33, the first joint 560 includes a main body 560a having a U shape as viewed in the extending direction (Z-axis direction) of the chain 510, and pin-shaped first and second link supports 560b, 560c extending outward from the main body 560a in opposite directions to each other. The first link support 560b links and supports two consecutive first links 520 pivotally with respect to each other about the first pivot centerline C1. In addition, the second link support 560c links and supports two consecutive second links 530 pivotally with respect to ach other about the third pivot centerline C3.

As illustrated in FIG. 32, the second joint 562 is placed within the double helix structure formed by the first helical link linkage 540 and the second helical link linkage 550. The second joint 562 includes a main body 562a having a U shape as viewed in the extending direction (Z-axis direction) of the chain 510, and pin-shaped third and fourth link supports 562b, 562c extending outward from the main body 562a in opposite directions to each other. The third link support 562b links and supports two consecutive first links 520 pivotally with respect to each other about the second pivot centerline C2. In addition, the fourth link support 562c links and supports two consecutive second links 530 pivotally with respect to each other about the fourth pivot centerline C4.

In the case of the sixth embodiment, the first joint 560 and the second joint 562 have the same shape.

Such first and second joints 560 and 562 form an internal space Is passing through the center of the cross section of the chain 510 and extending in the extending direction (Z-axis direction) of the chain 510, as illustrated in FIG. 35. The internal space Is can be used for arrangement of an air tube, a power cable, and the like.

Note that the first and second joints capable of forming the internal space extending in the extending direction of the chain in this manner in the chain can be realized in various shapes.

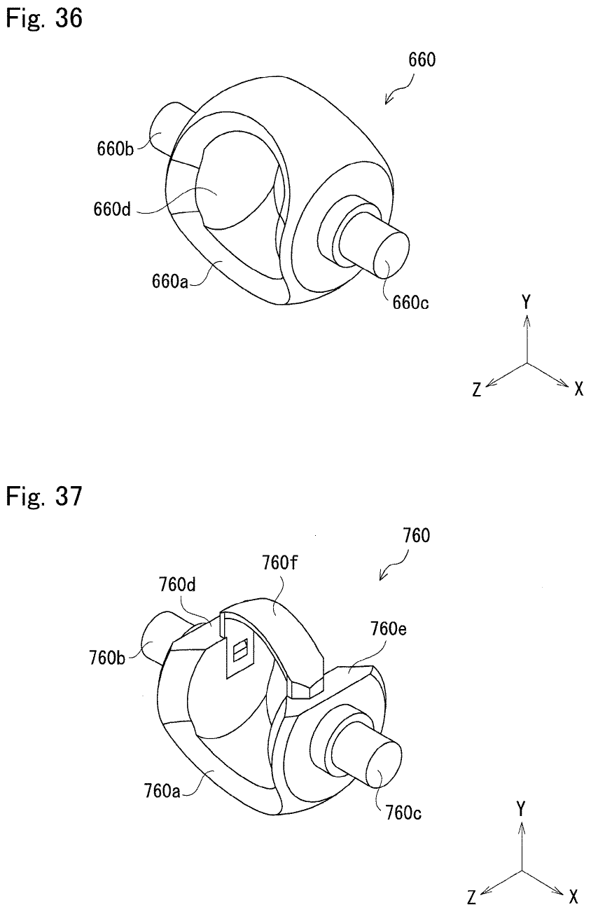

FIG. 36 is a perspective view illustrating another example of a joint. FIG. 37 is a perspective view illustrating still another example of a joint.

As illustrated in FIG. 36, another example of a joint 660 includes a main body portion 660a and pin-shaped first and second link supports 660b, 660c extending outward from the main body 660a in opposite directions to each other. The main body portion 660a has a through hole 660d penetrating in the extending direction (Z-axis direction) of the chain.

As illustrated in FIG. 37, still another example of a joint 760 includes a main body 760a having a U shape as viewed in the extending direction (Z-axis direction) of the chain, and pin-shaped first and second link supports 760b, 760c extending outward from the main body 760a in opposite directions to each other. The first and second link supports 760b, 760c are provided, and the side walls 760d, 760e of the main body 760a facing each other at an interval are connected via a connection member 760f. The connection member 760 also serves to protect a power cable or the like passing through the main body 760a.

In other words, the first and second joints each only needs to include a main body including a space penetrating therethrough in the extending direction (Z-axis direction) of the chain, a link support that links and supports two consecutive first links, and a link support that links and supports two consecutive second links. Note that differently from this, the first and second joints may be integrated with the first link and the second link.

Specifically, each of the first links has an inner portion placed inside with respect to an adjacent first link linked to one side, and has an outer portion placed outside with respect to another adjacent first link linked to the other side. Likewise, each of the second links has an inner portion placed inside with respect to an adjacent second link linked to one side, and has an outer portion placed outside with respect to another adjacent second link linked to the other side. For example, a through hole corresponding to a bush may be provided in each of the inner portions of the first links and the inner portions of the second links, and each of the link supports of the first and second joints may be integrally provided on a corresponding one of the outer portions of the first links and the outer portions of the second links while passing through a corresponding one of through holes. In other words, while each link support of the first and second joints is pivotally supported by a corresponding one of the through holes provided in the inner portions of the first and second links, each link support is non-pivotally supported by a corresponding one of the outer portions of the first and second links.

Similarly to the first embodiment described above, also in the sixth embodiment, the chain 510 that can be beat in a plurality of directions as viewed in the extending direction can have a highly versatile structure that can be used as it is.

The chain of the present disclosure is described above with reference to the first to sixth embodiments described above. However, the chain of the embodiment according to the present disclosure is not limited to the above-described first to sixth embodiments.

For example, in the case of the above-described first embodiment, each first pin 60 serves as a first role thereof to link two consecutive first links 20 pivotally with respect to each other about the first pivot centerline C1, and to link two consecutive second links 30 pivotally with respect to each other about the third pivot centerline C3. In addition, each second pin 62 serves as a first role thereof to link two consecutive first links 20 pivotally with respect to each other about the second pivot centerline C2, and to link two consecutive second links 30 pivotally with respect to each other about the fourth pivot centerline C4. On the other hand, each of the first pin 60 and the second pin 62 serves as its second role thereof to link the first helical link linkage 40 and the second helical link linkage 50, that is, to link the corresponding first link 20 and second link 30 as illustrated in FIG. 7. However, the embodiment of the present disclosure is not limited thereto.

For example, there may be an embodiment such that each of the first links includes a protrusion and a recess, and the protrusion and the recess of each of the two consecutive first links are pivotally engaged, thereby forming the first helical link linkage. Likewise, there may be an embodiment such that each of the second links includes a protrusion and a recess, and the protrusion and the recess of each of the two consecutive second links are pivotally engaged, thereby forming the second helical link linkage. In this case, linking of the first and second helical link linkages, that is, the linking of the corresponding first and second links is performed at portions other than the protrusions and recesses. For example, a portion between the protrusion and the recess in the first link and a portion between the protrusion and the recess in the corresponding second link may be linked by another member.

As described above, when each of the first and second links has a protrusion and a recess, the protrusion may be linked to the linking member. In this case, specifically, each of the first and second links has a protrusion and a through hole-shaped recess through which the protrusion passes. One end of the linking member is linked to the distal end of the protrusion of the first link passing through the recess of another adjacent first link, and the other end of the linking member is linked to the distal end of the protrusion of the second link passing through the recess of another adjacent second link.

Instead of the protrusion and the recess, a first link 20 may be pivotally linked to another first link 20 via a ball joint. Likewise, a second link 30 may also be pivotally linked to another second link 30 via a ball joint.

In the case of the above-described first embodiment, for example, as illustrated in FIG. 6, each of the first pivot centerlines C1 and the second pivot centerlines C2 of the first links 20 and each of the third pivot centerlines C3 and the fourth pivot centerlines C4 of the second links 30 extends in parallel to a plane (X-Y plane) orthogonal to the extending direction (Z-axis direction) of the chain 10. However, the embodiment of the present disclosure is not limited thereto. For example, the first and third pivot centerlines C1 and C3 located on the same straight line may be non-parallel to a plane orthogonal to the extending direction of the chain.

Furthermore, in the case of the above-described first embodiment, as illustrated in FIGS. 4B and 5B, the first and second links 20, 30 each have an L shape as viewed in the extending direction (Z-axis direction) of the chain 10. In addition, in the case of the above-described second embodiment, as illustrated in FIGS. 18A and 18B, the first and second links 120 and 130 each have an arc shape. However, in the embodiment of the present disclosure, the shapes of the first and second links are not limited thereto.

In addition, for example, it is also possible to combine the first and second links 20, 30 in the chain 10 according to the first embodiment and the first and second links 120 and 130 in the chain 110 according to the second embodiment to newly form chains of various variations.

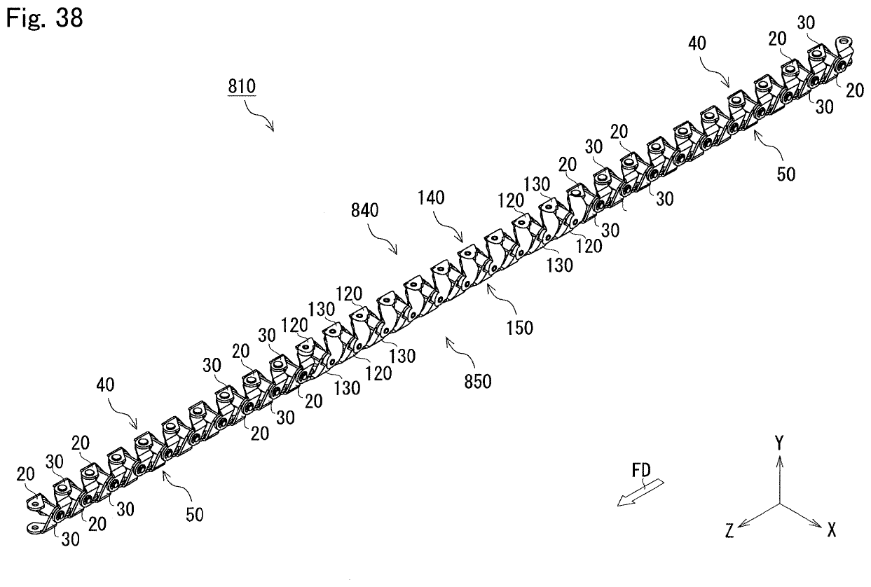

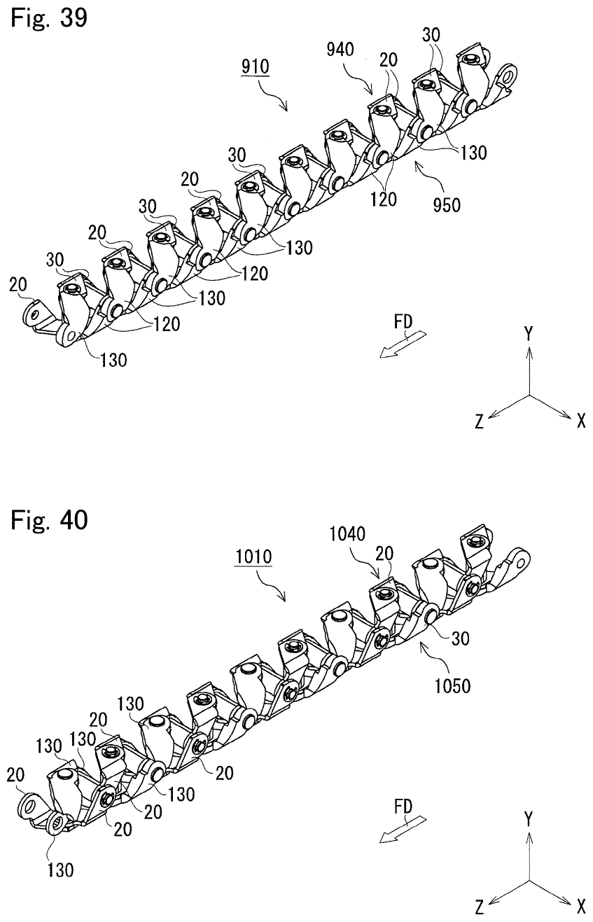

FIG. 38 is a perspective view of a part of a chain of an example variation. FIG. 39 is a perspective view of a part of a chain as another example variation. FIG. 40 is a perspective view of a part of a chain as still another example variation.

A chain 810 of an example variation illustrated in FIG. 38 is obtained by alternately linking the chains 10 according to the first embodiment and the chains 110 according to the second embodiment. Therefore, the first helical link linkage 840 is configured by alternately linking the first helical link linkage 40 according to the first embodiment and the first helical link linkage 140 according to the second embodiment. Likewise, the second helical link linkage 850 is configured by alternately linking the second helical link linkage 50 according to the first embodiment and the second helical link linkage 150 according to the second embodiment.

A chain 910 as another example variation illustrated in FIG. 39 is configured such that, as viewed in the extending direction (Z-axis direction) of the chain 910, the first and second links 20, 30 according to the first embodiment are located on one side in the width direction (X-axis direction) and on one side in the thickness direction (Y-axis direction), and the first and second links 120 and 130 according to the second embodiment are located on the other side in the width direction (X-axis direction) and on the other side in the thickness direction (Y-axis direction). Therefore, the first helical link structure 940 is configured by alternately linking two first links 20 according to the first embodiment and two second links 130 according to the second embodiment. In addition, the second helical link structure 950 is configured by alternately linking two second links 30 according to the first embodiment and two second links 130 according to the second embodiment. Therefore, the first link 20 and the second link 130 are in a correspondence relationship, and the first link 120 and the second link 30 are in a correspondence relationship.

In a chain 1010 as still another example variation illustrated in FIG. 40, the first helical linkage 1040 is formed of only the first links 20 according to the first embodiment, and the second helical linkage 1050 is formed of only the second links 130 according to the second embodiment. Therefore, each first link 20 and the corresponding second link 130 are in a correspondence relationship.

As described above, the first and second links 20, 30 according to the first embodiment and the first and second links 120 and 130 according to the second embodiment can be variously combined to create chains of various variations.

In the case of the first embodiment described above, the outer surfaces of the first and second links 20, 30 of the chain 10 are not fitted with options such as rollers. Also, the first and second pins 60, 62 do not protrude significantly from the outer surfaces of the first and second links 60, 62. Options such as rollers may be attached to the outer surfaces of the first and second links 20, 30, and the first and second pins 60, 62 may protrude significantly from the outer surfaces of the first and second links 20, 30, provided that the bending is not affected when the chain 10 is bent and used as desired. The same applies to the chains of other embodiments.

In addition, in the case of the above-described first embodiment, the chain 10 is used as power transmission means as illustrated in FIG. 11. However, the embodiment of the present disclosure is not limited thereto. When the chain includes an internal space extending in the extending direction of the chain as in the chain 510 of the sixth embodiment described above, the chain can be used as a cableveyor (registered trademark) instead of being used as power transmission means.

In other words, in a broad sense, the chain according to the embodiment of the present disclosure includes: a plurality of first links that are pivotally linked to each other and form a first helical link linkage extending helically; a plurality of second links that are pivotally linked to each other and form a second helical link linkage extending helically; and a plurality of linking members that link the first links and the second links corresponding one to one to the first links, to link the first helical link linkage and the second helical link linkage and form a double helix structure.

It is possible to optionally combine embodiments and modifications of the above-described embodiments and various modifications as appropriate, thereby achieving the effect that each has.

Although the present disclosure is fully described in connection with preferred embodiments with reference to the accompanying drawings, various modifications and changes are apparent to those skilled in the art. Such modifications and changes are to be understood as being included within the scope of the present disclosure as set forth in the appended claims. In addition, combinations of elements and changes in order in each embodiment can be realized without departing from the scope and spirit of the present disclosure.

### INDUSTRIAL APPLICABILITY

The present disclosure is applicable to chains to be used for various applications.

### REFERENCE SIGNS LIST

10 chain
20 first link
30 second link
40 first helical link linkage
50 second helical link linkage
60 linking member (first pin)
62 linking member (second pin)

1. A chain comprising:
a plurality of first links that are pivotally linked to each other and form a first helical link linkage extending helically;
a plurality of second links that are pivotally linked to each other and form a second helical link linkage extending helically; and
a plurality of linking members that link the first links and the second links corresponding one to one to the first links, to link the first helical link linkage and the second helical link linkage and form a double helix structure.

2. The chain according to claim 1, wherein
each first link has one side to which an adjacent first link is linked and has another side to which another adjacent first link is linked, the first link pivots with respect to the adjacent first link about a first pivot centerline, and the first link pivots with respect to the other adjacent first link about a second pivot centerline extending in a direction different from the first pivot centerline as viewed in an extending direction of the chain,
each second link has one side to which an adjacent second link is linked and has another side to which another adjacent second link is linked, the second link pivots with respect to the adjacent second link about a third pivot centerline, and the second link pivots with respect to the other adjacent second link about a fourth pivot centerline extending in a direction different from the third pivot centerline as viewed in the extending direction, and
the linking members link the first helical link linkage and the second helical link linkage such that: the first pivot centerline of each of the first links and the third pivot centerline of the corresponding one of the second links are located on a same straight line; and the second pivot centerline of each of the first links and a fourth pivot centerline of the corresponding one of the second links are located on a same straight line.

3. The chain according to claim 2, further comprising:
as the linking members,
first pins, each of which links and supports the two consecutive first links pivotally with respect to each other about the first pivot centerline, and links and supports the two consecutive second links pivotally with respect to each other about the third pivot centerline; and
second pins, each of which links and supports the two consecutive first links pivotally with respect to each other about the second pivot centerline, and links and supports the two consecutive second links pivotally with respect to each other about the fourth pivot centerline.

4. The chain according to claim 2, further comprising:
as the linking members,
first joints, each of which includes a first link support that links and supports the two consecutive first links pivotally with respect to each other about the first pivot centerline, a second link support that links and supports the two consecutive second links pivotally with respect to each other about the third pivot centerline, and a main body including a space penetrating in an extending direction of the chain; and
second joints, each of which includes a third link support that links and supports the two consecutive first links pivotally with respect to each other about the second pivot centerline, a fourth link support that links and supports the two consecutive second links pivotally with respect to each other about the fourth pivot centerline, and a main body including a space penetrating in an extending direction of the chain.

5. The chain according to claim 2, wherein each of the first pivot centerlines and a corresponding one of the second pivot centerlines are orthogonal to each other at an angle of 90 degrees as viewed in the extending direction.

6. The chain according to claim 2, wherein each of the first pivot centerlines and a corresponding one of the second pivot centerlines cross at an angle of 60 degrees as viewed in the extending direction.

7. The chain according to claim 1, wherein each of the first links and the second links has an L-shape as viewed in an extending direction of the chain such that contours of the first helical link linkage and the second helical link linkage each have a rectangular shape as viewed in an extending direction of the chain.

8. The chain according to claim 1, wherein each of the first links and the second links has an arc shape as viewed in an extending direction of the chain such that contours of the first helical link linkage and the second helical link linkage each have a circular shape as viewed in an extending direction of the chain.

9. The chain according to claim 1, wherein each of the first links and the second links has a same shape.

10. The chain according to claim 1, wherein
the first links are a plurality of types of first links having different shapes from each other, and
the second links are a plurality of types of second links having different shapes from each other.

11. The chain according to claim 10, wherein the plurality of types of first links and the plurality of types of second links include links of a same shape.
